(19) United States
(12) Patent Application Publication
(10) Pub. No.: US 2020/0380456 A1
(43) Pub. Date: Dec. 3, 2020

(54) FOUND OBJECT MANAGEMENT SYSTEM, CONTROL METHOD FOR AN INFORMATION PROCESSING DEVICE, AND CONTROL METHOD FOR A COMMUNICATIONS TERMINAL

(71) Applicant: NEC CORPORATION, Tokyo (JP)

(72) Inventor: Rui ISHIYAMA, Tokyo (JP)

(73) Assignee: NEC CORPORATION, Tokyo (JP)

(21) Appl. No.: 16/766,541

(22) PCT Filed: Nov. 30, 2018
(86) PCT No.: PCT/JP2018/044115

§ 371 Date: May 22, 2020

(30) Foreign Application Priority Data
Dec. 4, 2017 (JP) 2017-232792

(51) Int. Cl. G06Q 10/08; G06K 9/00; G06Q 30/06; G06K 7/14

(52) U.S. Cl. CPC G06Q 10/087; G06K 9/00577; G06K 7/1413; G06Q 30/0627; G06Q 30/0639

(57) ABSTRACT

The present invention reduces the time and cost to manage found objects, and comprises: a sale information acquisition unit which, if an object is sold, acquires a first object identifier identifying the sold object, and acquires ownership rights surrender information indicating that ownership rights to the sold object are surrendered if the buyer loses the sold object; a recording unit which associates and records the first object identifier with the ownership rights surrender information; a found information acquisition unit which acquires a second object identifier identifying a found object; a comparison unit which compares the second object identifier and the first object identifier; and a notification unit which, if the second object identifier and the first object identifier match, sends a notification that the ownership rights to the found object have been surrendered.

### TECHNICAL FIELD

The present disclosure relates to a technology of managing a found object, and the like.

### BACKGROUND ART

In the aforementioned technical field, PTL 1 discloses a technology of previously registering a color code including contact information, confirming that an information terminal user is a loser of a lost object himself/herself by use of the color code, and approving transfer of a found object to the loser. PTL 2 discloses a technology of storing an article ID and a point to be paid when the article is found, and paying the point when the article ID matches an article ID of an article found by a finder.

### CITATION LIST

### Patent Literature

PTL 1: Japanese Unexamined Patent Application Publication No. 2016-118898

PTL 2: Japanese Unexamined Patent Application Publication No. 2017-084032

PTL 3: International Application Publication No. WO 2017/002475

PTL 4: International Application Publication No. WO 2017/047306

### SUMMARY OF INVENTION

### Technical Problem

However, in the technologies described in the aforementioned literatures, when a lost object is found, a large amount of time and expense has been wasted for locating an owner of the found object himself/herself and returning the object to the owner, which is accompanied by work for locating the owner himself/herself, work for keeping the found object for a certain period of time when the owner himself/herself is not located, and the like.

An object of the present disclosure is to provide a technology resolving the aforementioned problem.

### Solution to Problem

In order to achieve the aforementioned object, a found object management system according to an aspect of the present disclosure includes: a sales information acquisition unit for, when an object is sold, acquiring a first object identifier for identifying the sold object and ownership abandonment information indicating that ownership of the sold object is abandoned when a purchaser loses the sold object; a registration unit for registering the first object identifier and the ownership abandonment information in association with each other; a finding information acquisition unit for acquiring a second object identifier for identifying a found object; a checking unit for checking the second object identifier against the first object identifier; and a notification unit for, when the second object identifier matches the first object identifier, notifying that ownership of the found object is abandoned.

In order to achieve the aforementioned object, a found object management method according to an aspect of the present disclosure includes: when an object is sold, acquiring a first object identifier for identifying the sold object and ownership abandonment information indicating that ownership of the sold object is abandoned when a purchaser loses the sold object; registering the first object identifier and the ownership abandonment information in association with each other into a registration unit; acquiring a second object identifier for identifying a found object; checking the second object identifier against the first object identifier; and, when the second object identifier matches the first object identifier, notifying that ownership of the found object is abandoned.

In order to achieve the aforementioned object, a found object management program according to an aspect of the present disclosure causes a computer to execute: sales information acquisition processing of, when an object is sold, acquiring a first object identifier for identifying the sold object and ownership abandonment information indicating that ownership of the sold object is abandoned when a purchaser loses the sold object; registration processing of registering the first object identifier and the ownership abandonment information in association with each other; finding information acquisition processing of acquiring a second object identifier for identifying a found object; checking processing of checking the second object identifier against the first object identifier; and notification processing of, when the second object identifier matches the first object identifier, notifying that ownership of the found object is abandoned.

In order to achieve the aforementioned object, an information processing device according to an aspect of the present disclosure includes: a registration unit for registering a first object identifier for identifying a sold object and ownership abandonment information indicating that ownership of the sold object is abandoned when a purchaser loses the sold object, in association with each other; a finding information reception unit for receiving a second object identifier for identifying a found object; a checking unit for checking the second object identifier against the first object identifier; and a determination unit for, when the second object identifier matches the first object identifier, determining that ownership of the found object is abandoned.

In order to achieve the aforementioned object, a control method for an information processing device according to an aspect of the present disclosure includes: registering a first object identifier for identifying a sold object and ownership abandonment information indicating that ownership of the sold object is abandoned when a purchaser loses the sold object, in association with each other, into a registration unit; receiving a second object identifier for identifying a found object; checking the second object identifier against the first object identifier; and, when the second object identifier matches the first object identifier, determining that ownership of the found object is abandoned.

In order to achieve the aforementioned object, an information processing program according to an aspect of the present disclosure causes a computer to execute: registration processing of registering a first object identifier for identifying a sold object and ownership abandonment information indicating that ownership of the sold object is abandoned when a purchaser loses the sold object, in association with each other, into a registration unit; finding information reception processing of receiving a second object identifier for identifying a found object; checking processing of checking the second object identifier against the first object identifier; and determination processing of, when the second object identifier matches the first object identifier, determining that ownership of the found object is abandoned.

In order to achieve the aforementioned object, a sale management device according to an aspect of the present disclosure includes: a sales information acquisition unit for, when an object is sold, acquiring a first object identifier for identifying the sold object and ownership abandonment information indicating that ownership of the sold object is abandoned when a purchaser loses the sold object; and a sales information transmission unit for transmitting, to an information processing device, the first object identifier and the ownership abandonment information to be registered in association with each other into a registration unit in the information processing device.

In order to achieve the aforementioned object, a control method for a sale management device according to an aspect of the present disclosure includes: when an object is sold, acquiring a first object identifier for identifying the sold object and ownership abandonment information indicating that ownership of the sold object is abandoned when a purchaser loses the sold object; and transmitting, to an information processing device, the first object identifier and the ownership abandonment information to be registered in association with each other into a registration unit in the information processing device.

In order to achieve the aforementioned object, a control program for a sale management device according to an aspect of the present disclosure causes a computer to execute: sales information acquisition processing of, when an object is sold, acquiring a first object identifier for identifying the sold object and ownership abandonment information indicating that ownership of the sold object is abandoned when a purchaser loses the sold object; and sales information transmission processing of transmitting, to an information processing device, the first object identifier and the ownership abandonment information to be registered in association with each other into a registration unit in the information processing device.

In order to achieve the aforementioned object, a communications terminal according to an aspect of the present disclosure includes: a finding information acquisition unit for acquiring a second object identifier for identifying a found object; a finding information transmission unit for transmitting the second object identifier to an information processing device; an abandonment information reception unit for receiving ownership abandonment information indicating that ownership of the found object is abandoned, the abandonment information being notified from the information processing device when a first object identifier for identifying a sold object matching the second object identifier is registered in a registration unit in the information processing device; and an abandonment information notification unit for notifying that ownership of the found object is abandoned, based on the received ownership abandonment information.

In order to achieve the aforementioned object, a control method for a communications terminal according to an aspect of the present disclosure includes: acquiring a second object identifier for identifying a found object; transmitting the second object identifier to an information processing device; receiving ownership abandonment information indicating that ownership of the found object is abandoned, the abandonment information being notified from the information processing device when a first object identifier for identifying a sold object matching the second object identifier is registered in a registration unit in the information processing device; and notifying that ownership of the found object is abandoned, based on the received ownership abandonment information.

In order to achieve the aforementioned object, an application program for a communications terminal according to an aspect of the present disclosure causes a computer to execute: finding information acquisition processing of acquiring a second object identifier for identifying a found object; finding information transmission processing of transmitting the second object identifier to an information processing device; abandonment information reception processing of receiving ownership abandonment information indicating that ownership of the found object is abandoned, the abandonment information being notified from the information processing device when a first object identifier for identifying a sold object matching the second object identifier is registered in a registration unit in the information processing device; and abandonment information notification processing of notifying that ownership of the found object is abandoned, based on the received ownership abandonment information.

An aspect of the present disclosure is also provided by a storage medium having the aforementioned found object management program, information processing program, or application program for a communications terminal stored thereon.

### Advantageous Effects of Invention

The present disclosure can reduce time and expense for managing a found object.

### BRIEF DESCRIPTION OF DRAWINGS

FIG. 1 is a block diagram illustrating a configuration of a found object management system according to a first example embodiment of the present disclosure.

FIG. 2A is a diagram illustrating a social model using a found object management system according to every example embodiment of the present disclosure.

FIG. 2B is a diagram illustrating an outline of a found object management system according to a second example embodiment of the present disclosure.

FIG. 2C is a diagram illustrating an outline of the found object management system according to the second example embodiment of the present disclosure.

FIG. 2D is a diagram illustrating an outline of the found object management system according to the second example embodiment of the present disclosure.

FIG. 2E is a diagram illustrating object identifiers used in the found object management system according to the second example embodiment of the present disclosure.

FIG. 3A is a sequence diagram illustrating an operation procedure of the found object management system according to the second example embodiment of the present disclosure.

FIG. 3B is a sequence diagram illustrating another operation procedure of the found object management system according to the second example embodiment of the present disclosure.

FIG. 4 is a block diagram illustrating a functional configuration of a found object management server as an information processing device according to the second example embodiment of the present disclosure.

FIG. 5 is a diagram illustrating a structure of a found object management database according to the second example embodiment of the present disclosure.

FIG. 6 is a block diagram illustrating a functional configuration of a sale management device according to the second example embodiment of the present disclosure.

FIG. 7 is a block diagram illustrating a functional configuration of a found object management device according to the second example embodiment of the present disclosure.

FIG. 8 is a block diagram illustrating a hardware configuration of the found object management server as the information processing device according to the second example embodiment of the present disclosure.

FIG. 9 is a flowchart illustrating a processing procedure in the found object management server as the information processing device according to the second example embodiment of the present disclosure.

FIG. 10 is a block diagram illustrating a hardware configuration of the sale management device according to the second example embodiment of the present disclosure.

FIG. 11 is a flowchart illustrating a processing procedure in the sale management device according to the second example embodiment of the present disclosure.

FIG. 12 is a block diagram illustrating a hardware configuration of the found object management device according to the second example embodiment of the present disclosure.

FIG. 13 is a flowchart illustrating a processing procedure in the found object management device according to the second example embodiment of the present disclosure.

FIG. 14 is a diagram illustrating an outline of a found object management system according to a third example embodiment of the present disclosure.

FIG. 15 is a sequence diagram illustrating an operation procedure of the found object management system according to the third example embodiment of the present disclosure.

FIG. 16 is a block diagram illustrating a functional configuration of a found object management server as an information processing device according to the third example embodiment of the present disclosure.

FIG. 17 is a diagram illustrating a structure of a found object management database according to the third example embodiment of the present disclosure.

FIG. 18 is a flowchart illustrating a processing procedure in the found object management server as the information processing device according to the third example embodiment of the present disclosure.

FIG. 19 is a block diagram illustrating a functional configuration of a sale management device according to the third example embodiment of the present disclosure.

FIG. 20 is a flowchart illustrating a processing procedure in the sale management device according to the third example embodiment of the present disclosure.

FIG. 21 is a block diagram illustrating a functional configuration of a found object management device according to the third example embodiment of the present disclosure.

FIG. 22 is a flowchart illustrating a processing procedure in the found object management device according to the third example embodiment of the present disclosure.

FIG. 23 is a sequence diagram illustrating an operation procedure of a found object management system according to a fourth example embodiment of the present disclosure.

FIG. 24 is a block diagram illustrating a functional configuration of a found object management server as an information processing device according to the fourth example embodiment of the present disclosure.

FIG. 25 is a diagram illustrating a structure of a found object management database according to the fourth example embodiment of the present disclosure.

FIG. 26 is a flowchart illustrating a processing procedure in the found object management server as the information processing device according to the fourth example embodiment of the present disclosure.

FIG. 27 is a diagram illustrating an outline of a found object management system according to a fifth example embodiment of the present disclosure.

FIG. 28 is a sequence diagram illustrating an operation procedure of the found object management system according to the fifth example embodiment of the present disclosure.

FIG. 29 is a block diagram illustrating a functional configuration of a smartphone as a found object management device according to the fifth example embodiment of the present disclosure.

FIG. 30 is a block diagram illustrating a hardware configuration of the smartphone as the found object management device according to the fifth example embodiment of the present disclosure.

FIG. 31 is a flowchart illustrating a processing procedure in the smartphone as the found object management device according to the fifth example embodiment of the present disclosure.

### EXAMPLE EMBODIMENT

Example embodiments of the present disclosure will be exemplarily described in detail below with reference to drawings. Note that components described in the following example embodiments are mere exemplifications and are not intended to limit the technical scope of the present disclosure to the components only.

### First Example Embodiment

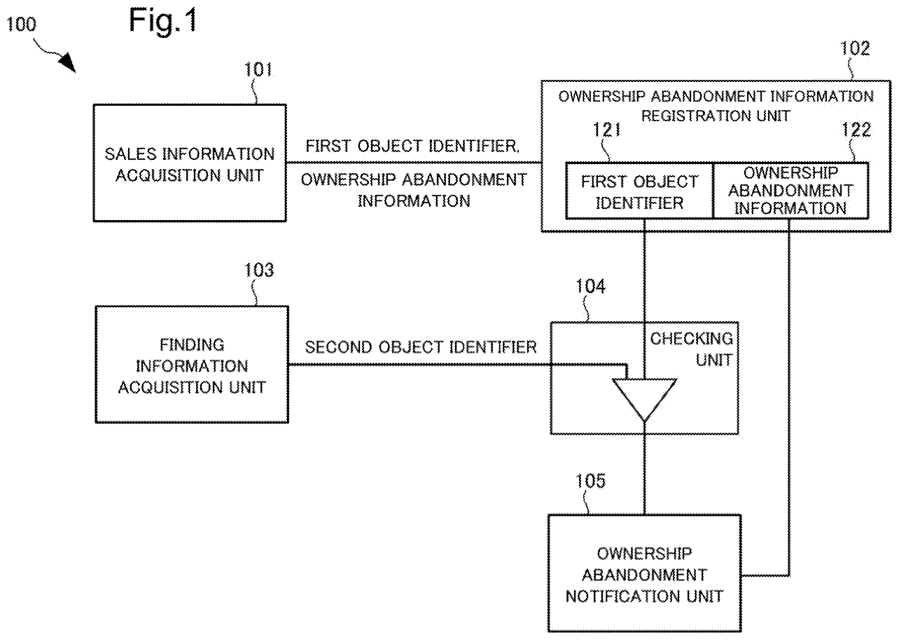

A found object management system 100 according to a first example embodiment of the present disclosure will be described by use of FIG. 1. The found object management system 100 is a system managing handling of a found object.

As illustrated in FIG. 1, the found object management system 100 includes a sales information acquisition unit 101, an ownership abandonment information registration unit 102, a finding information acquisition unit 103, a checking unit 104, and an ownership abandonment notification unit 105. When an object is sold, the sales information acquisition unit 101 acquires a first object identifier for identifying the sold object and ownership abandonment information indicating that ownership of the sold object is abandoned when the purchaser loses the sold object. The ownership abandonment information registration unit 102 registers the first object identifier 121 and the ownership abandonment information 122 in association with each other. The finding information acquisition unit 103 acquires a second object identifier for identifying a found object. The checking unit 104 checks the second object identifier against the first object identifier. When the second object identifier and the first object identifier match, the ownership abandonment notification unit 105 notifies that ownership of the found object is abandoned.

According to the present example embodiment, ownership abandonment information indicating that ownership of a sold object is abandoned when a purchaser loses the sold object is set at the point of sale, and therefore time and expense for managing a found object can be reduced.

### Second Example Embodiment

Next, a found object management system according to a second example embodiment of the present disclosure will be described. At a point of sale of an object, the found object management system according to the present example embodiment registers ownership abandonment information indicating that ownership of the sold object is abandoned when a purchaser loses the sold object, in association with an object identifier for identifying the object, into a found object management database in a found object management server. Then, the found object management system acquires an object identifier for identifying an object of a found object found by a finder and checks the object identifier against an object identifier registered in the found object management database. When the object identifier of the found object and the object identifier registered by the purchaser match, ownership of the sold object is abandoned, and therefore a finder or a handler handling the found object may dispose of the found object by his/her own determination. An identifier using a barcode, a microscopic grain distribution in a dot, a feature value of an object, or the like may be suitably selected and used as an object identifier, depending on a size, a material, and/or the like of the object. Object identifiers may be determined to match when the difference between the two is equal to or less than a predetermined threshold value.

### Found Object Management System

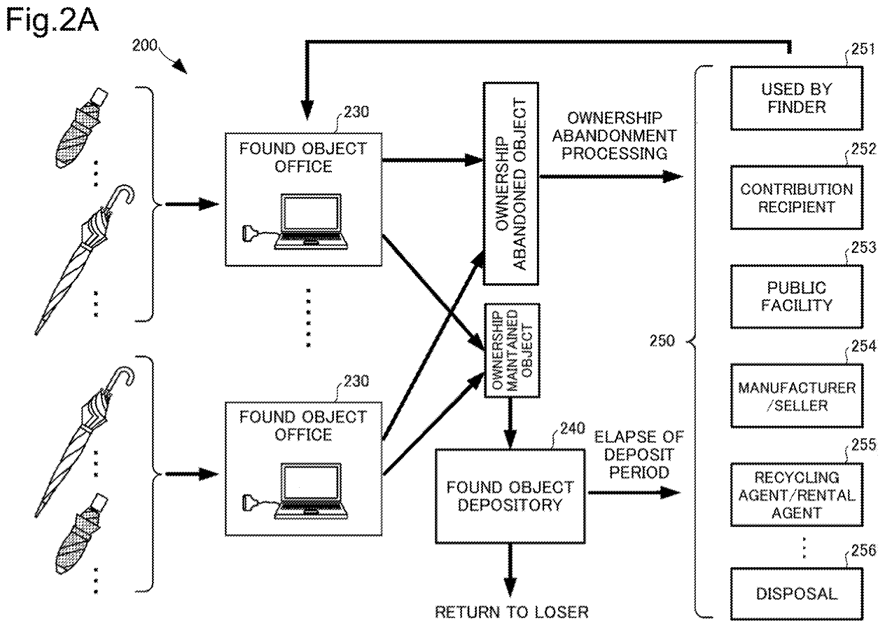

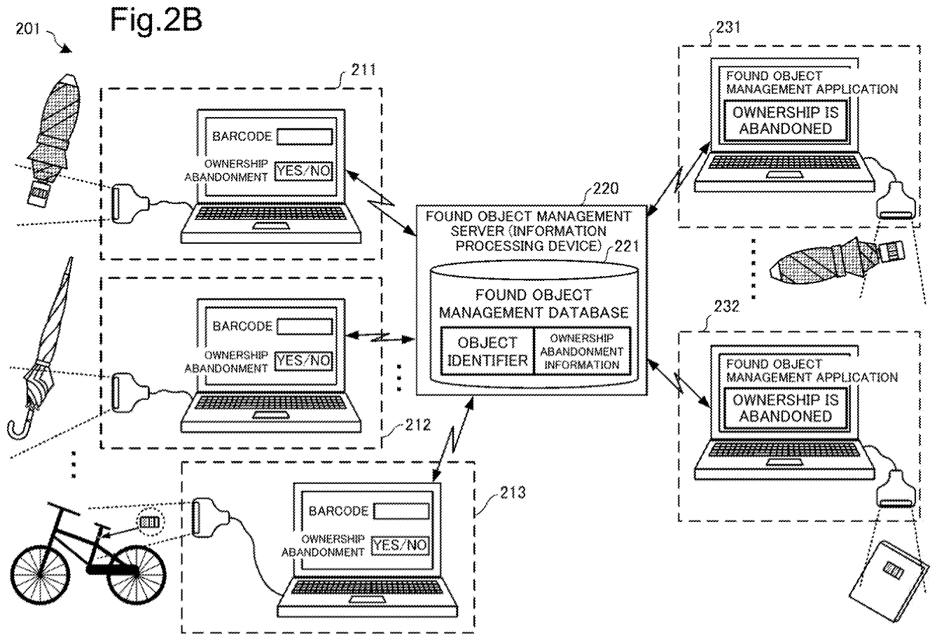

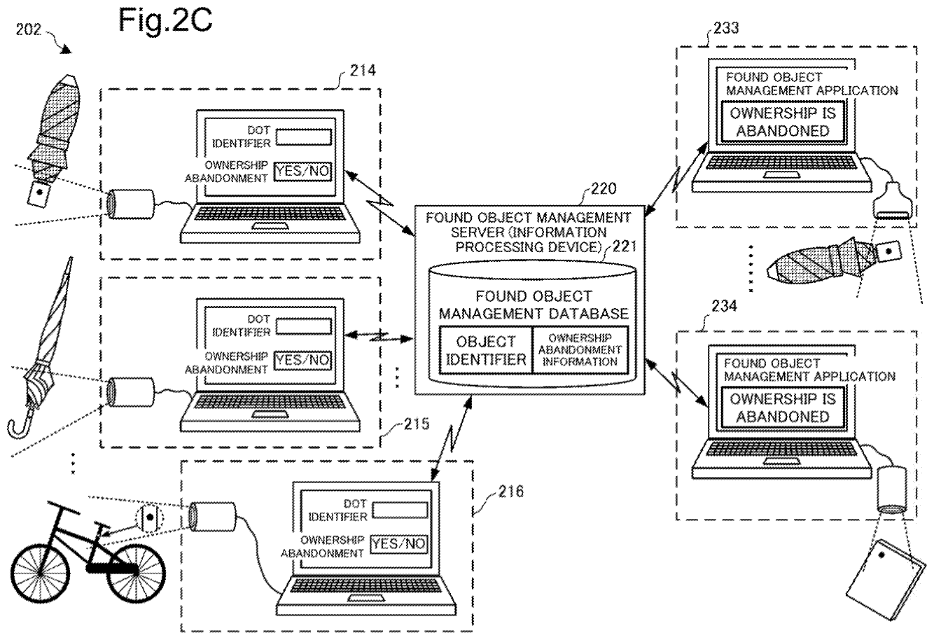

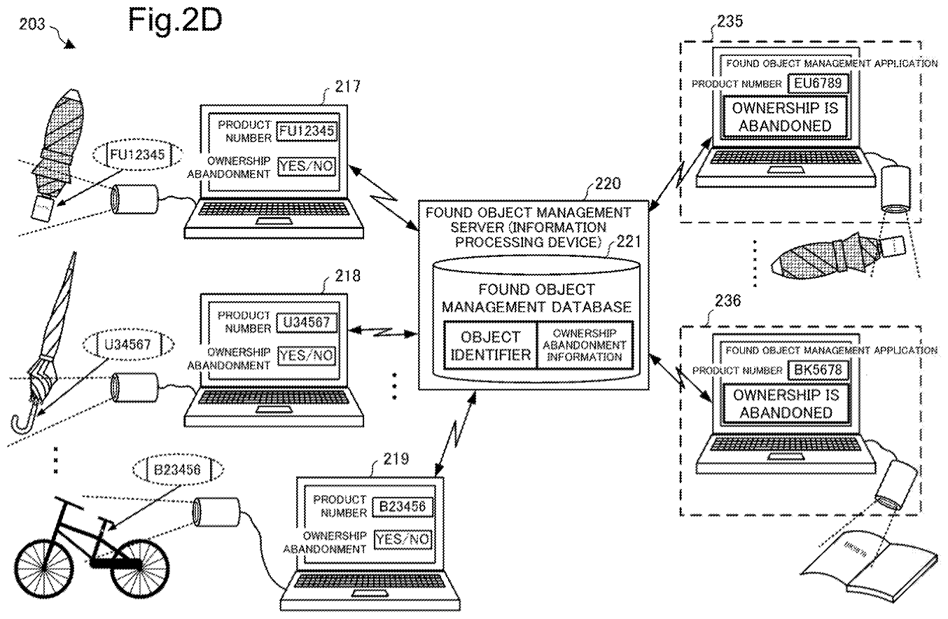

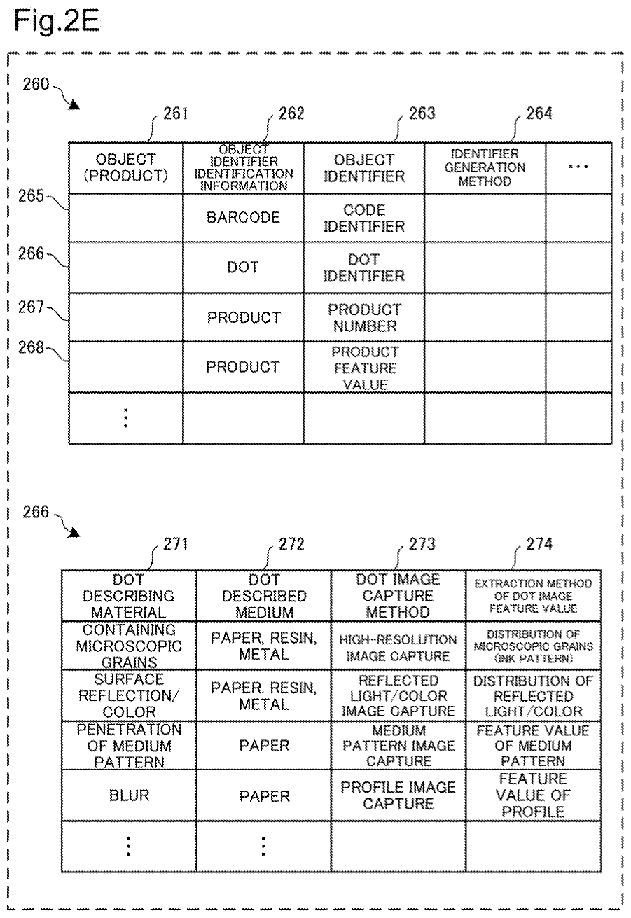

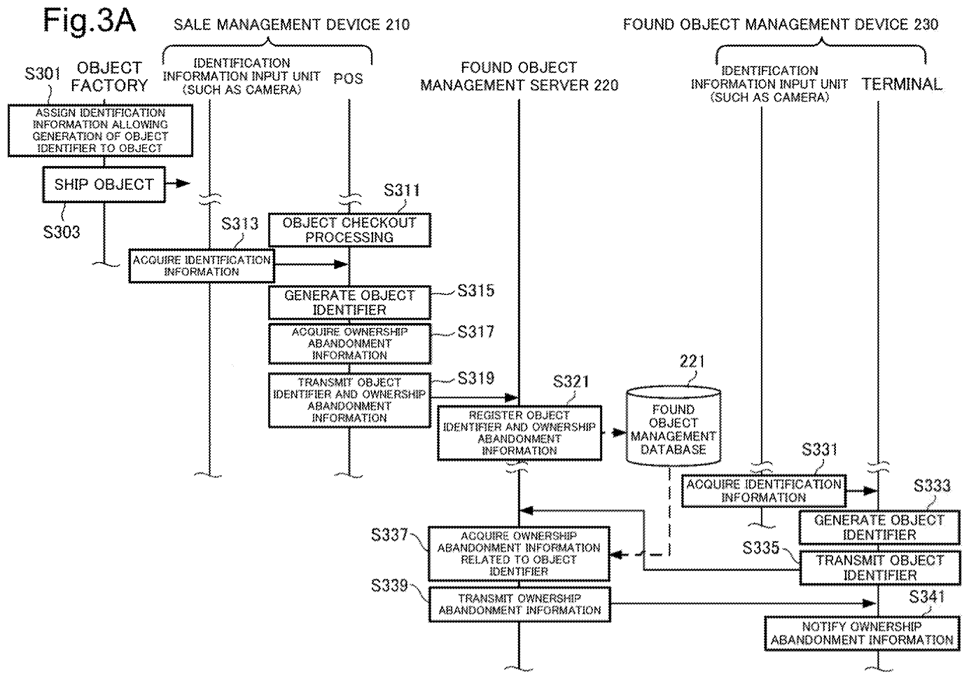

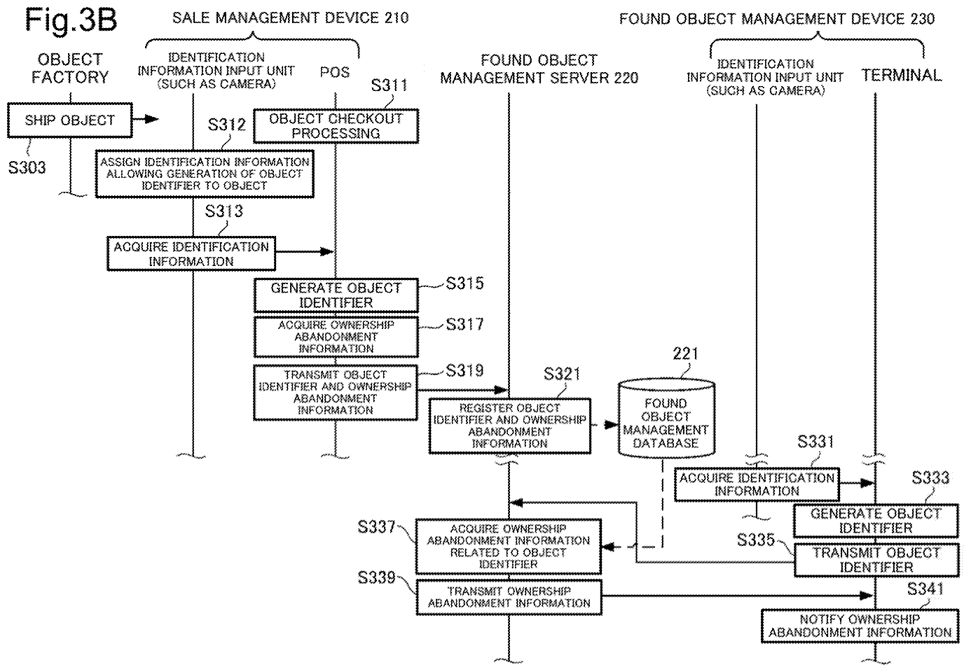

A configuration and an operation of the found object management system according to the present example embodiment will be described with reference to FIG. 2A to FIG. 3B.

### Social Model

FIG. 2A is a diagram illustrating a social model using a found object management system 200 according to the present example embodiment. While an umbrella will be described as an example of an object being sold, lost, and found in FIG. 2A, a found object is not limited to an umbrella.

In the found object management system 200, many umbrellas are brought into a plurality of found object offices 230 as found objects. The umbrellas are brought in by a finder or are brought in by a caretaker of a building, a person concerned with a transportation facility, the police, or the like. At a found object office 230, umbrellas are sorted into umbrellas ownership of which is abandoned and umbrellas ownership of which is maintained (not abandoned) by generating an object identifier from object identification information assigned to each umbrella, according to the present example embodiment, and checking the object identifier against an object identifier being associated with ownership abandonment information and being registered at a point of sale. Then, an umbrella ownership of which is maintained is kept for a certain period of time in a found object depository 240.

On the other hand, an umbrella ownership of which is abandoned is transferred to a transfer destination 250 specified by the loser, based on a determination by a finder or a handler at the found object office 230, or as indicated in the third example embodiment to be described later. For example, the transfer destination 250 includes use by the finder 251, contribution to a contribution recipient 252, contribution to a public facility 253, return to a manufacturer/seller 254, transfer to a recycling agent/rental agent 255, or disposal 256. When there is no collection by a loser after a found object is kept for a certain period of time in a found object depository 240, the object is disposed of based on a determination by a handler of the found object depository 240.

Furthermore, when a found object is lost during use at a transfer destination 250, recycling of the object from a found object office 230 to the transfer destination 250 without delay caused by keeping the object in a found object depository 240 again can be linked to a sharing society making effective use of limited resources. Recycling full of variety can be achieved by setting a different transfer destination to an object found again

### Outline

FIG. 2B is a diagram illustrating an outline of a found object management system 201 according to the present example embodiment. A code identifier using a barcode is used as an object identifier in the found object management system 201.

The found object management system 201 includes sale management devices 211 to 213 at a plurality of sales outlets, a found object management server 220 as an information processing device, and found object management devices 231 and 232 at a plurality of found object offices. Each of the sale management devices 211 to 213 and the found object management devices 231 and 232 includes a communications terminal and an identification information input unit such as a barcode reader or a camera.

In the sale management devices 211 to 213, a barcode stuck to a folding umbrella, an ordinary umbrella, a bicycle, or the like being a sold object is read with a barcode reader as an object identifier, and ownership abandonment information indicating abandonment of ownership in a case of the sold object being lost is set. The object identifier and the ownership abandonment information are transmitted in association with each other to the found object management server 220 and are registered into a found object management database 221.

On the other hand, in the found object management devices 231 and 232, a barcode stuck to a found object is read with a barcode reader as an object identifier, and the object identifier is transmitted to the found object management server 220. In the found object management server 220, an object identifier received from the found object management devices 231 and 232 is checked against an object identifier registered in the found object management database 221. Then, when the received object identifier matches the registered object identifier, ownership abandonment information registered in association with the object identifier in the found object management database 221 is read and is transmitted to the found object management device 231 or 232. Object identifiers may be determined to match when the difference between the two is within a predetermined threshold value.

In FIG. 2B, since matching object identifiers have ownership abandonment information, the found object management device 231 displays a message “OWNERSHIP IS ABANDONED” on a display screen and notifies abandonment of ownership. A handler at the found object office confirms the ownership abandonment and disposes of an umbrella being a found object without keeping the object in the found object depository 240, based on his/her own determination. Since matching object identifiers are not registered or do not have ownership abandonment information, the found object management device 232 displays a message “OWNERSHIP IS MAINTAINED” on a display screen and notifies maintenance of ownership. A handler at the found object office confirms the ownership maintenance, keeps a book being a found object in the found object depository 240, and awaits a loser to be found.

FIG. 2C is a diagram illustrating an outline of a found object management system 202 according to the present example embodiment. A dot identifier extracted from a captured image of a dot described on an object is used as an object identifier in the found object management system 202. In FIG. 2C, a component similar to that in FIG. 2B is given the same reference number.

The found object management system 202 includes sale management devices 214 to 216 at a plurality of sales outlets, the found object management server 220 as the information processing device, and found object management devices 233 and 234 at a plurality of found object offices.

In the sale management devices 214 to 216, a dot described on a folding umbrella, an ordinary umbrella, a bicycle, or the like being a sold object is read with a high-resolution camera, a dot identifier extracted from the dot is set as an object identifier, and ownership abandonment information indicating abandonment of ownership in a case of the sold object being lost is set. The object identifier and the ownership abandonment information are transmitted in association with each other to the found object management server 220 and are registered into the found object management database 221.

On the other hand, in the found object management devices 233 and 234, a dot described on a found object is read with a high-resolution camera, a dot identifier extracted from the dot is set as an object identifier, and the object identifier is transmitted to the found object management server 220. In the found object management server 220, an object identifier received from the found object management devices 233 and 234 is checked against an object identifier registered in the found object management database 221. Then, when the received object identifier matches the registered object identifier, ownership abandonment information registered in the found object management database 221 in association with the object identifier is read and is transmitted to the found object management device 233 or 234.

In FIG. 2C, since matching object identifiers have ownership abandonment information, the found object management device 233 displays a message “OWNERSHIP IS ABANDONED” on a display screen and notifies abandonment of ownership. A handler at the found object office confirms the ownership abandonment and disposes of an umbrella being a found object without keeping the object in the found object depository 240, based on his/her own determination. Since matching object identifiers are not registered or do not have ownership abandonment information, the found object management device 234 displays a message “OWNERSHIP IS MAINTAINED” on a display screen and notifies maintenance of ownership. A handler at the found object office confirms the ownership maintenance, keeps a book being a found object in the found object depository 240, and awaits a loser to be found.

FIG. 2D is a diagram illustrating an outline of a found object management system 203 according to the present example embodiment. A product number or a serial number described or marked on an object is used as an object identifier in the found object management system 203. In FIG. 2D, a component similar to that in FIG. 2B or FIG. 2C is given the same reference number.

The found object management system 203 includes sale management devices 217 to 219 at a plurality of sales outlets, the found object management server 220 as the information processing device, and found object management devices 235 and 236 at a plurality of found object offices.

In the sale management devices 217 to 219, a product number described or marked on a folding umbrella, an ordinary umbrella, a bicycle, or the like being a sold object is read with a high-resolution camera, a product number recognized from the image is set as an object identifier, and ownership abandonment information indicating abandonment of ownership in a case of the sold object being lost is set. The object identifier and the ownership abandonment information are transmitted in association with each other to the found object management server 220 and are registered into the found object management database 221.

On the other hand, in the found object management devices 235 and 236, a product number described or marked on a found object is read with a high-resolution camera, a product number recognized from the image is set as an object identifier, and the object identifier is transmitted to the found object management server 220. In the found object management server 220, an object identifier received from the found object management devices 235 and 236 is checked against an object identifier registered in the found object management database 221. Then, when the received object identifier matches the registered object identifier, ownership abandonment information registered in the found object management database 221 in association with the object identifier is read and is transmitted to the found object management device 235 or 236.

In FIG. 2D, since matching object identifiers have ownership abandonment information, the found object management device 235 displays a message “OWNERSHIP IS ABANDONED” on a display screen and notifies abandonment of ownership. A handler at the found object office confirms the ownership abandonment and disposes of an umbrella being a found object without keeping the object in the found object depository 240, based on his/her own determination. Since matching object identifiers are not registered or do not have ownership abandonment information, the found object management device 236 displays a message “OWNERSHIP IS MAINTAINED” on a display screen and notifies maintenance of ownership. A handler at the found object office confirms the ownership maintenance, keeps a book being a found object in the found object depository 240, and awaits a loser to be found.

Objects to which ownership abandonment information is set are not limited to an umbrella, a bicycle, and a book that are illustrated in FIG. 2B to FIG. 2D, and have only to be sharable objects including a writing tool. For example, glasses and clothes to be worn become sharable by applying recycling treatment. Furthermore, some food or the like may be transferable before a best before date. Without being limited to FIG. 2B to FIG. 2D, something allowing generation of an identifier for identifying each object is used as an object identifier. For example, a feature value extracted from a captured image of an object may be used.

Usable Object Identifier FIG. 2E is a diagram illustrating object identifiers used in the found object management system 200 according to the present example embodiment.

The upper diagram in FIG. 2E is an object identifier table 260 indicating examples of an object identifier used in the present example embodiment. The object identifier table 260 stores object identifier identification information 262 desirable for each object (product) 261, an object identifier 263 generated from the object identifier identification information 262, and a generation method 264 of the object identifier 263, in association with the object (product) 261 attached with the object identifier identification information. The object identifier identification information 262 includes a one-dimensional or two-dimensional barcode stuck to an object (product) 261, a dot described on an object (product) 261, and a feature point identifier extracted from an object (product) 261 itself. The object identifiers 263 include a code identifier, a dot identifier, a serial number or a product number printed or marked on an object (product) 261, and a feature value extracted from a captured image of a product or the like. A relation between each object (product) 261 and desirable object identifier identification information 262 may be selected in consideration of a size, a material, a color, and the like of the object (product) 261. Each of rows 265 to 268 of the object identifier table 260 summarizes each object (product) and an object identifier being used.

### Dot Identifier Extraction Method

A dot identifier table 266 being the lower diagram in FIG. 2E is a diagram further illustrating examples of a dot identifier being extracted from a dot described on an object (property) with a writing tool and being suitable in the present example embodiment. A description method of a dot allowing extraction of a dot identifier is not limited to FIG. 2E.

Dot describing materials 271 include a material containing microscopic grains (hereinafter also referred to as an ink pattern), a material having characteristic surface reflection and/or a characteristic color pattern, a material through which a pattern of a medium (paper) penetrates, and a material on which a blur on a medium (paper) appears. Each restriction on a dot description medium 272, each of differences between dot image capture methods 273, and each extraction method 274 of a feature value of a dot image as a dot identifier are described as illustrated in the diagram. A material containing microscopic grains is hereinafter used in the present example embodiment as a material allowing description of a dot allowing extraction of a dot identifier on a wide range of media, allowing an image capture unit to be portable and to provide a stable captured image, and allowing easy extraction of an identifiable dot identifier. However, the dot material, the dot description method, the dot image capture method, and the dot identifier extraction method are not limited to the above and may be any material or method allowing generation of an identifiable dot identifier whether described in FIG. 2E or not.

Details of extraction of a dot identifier from a dot with a material containing microscopic grains are disclosed in, for example, PTL 3 or PTL 4.

### Operational Sequence

FIG. 3A is a sequence diagram illustrating an operation procedure of the found object management system 200 according to the present example embodiment. FIG. 3A is an operational sequence of the found object management system 200 assigning identification information allowing generation of an object identifier in a factory (manufacturing plant) of an object or in distribution, at or before sale of the object.

As a preparation for operation of the found object management system 200, identification information allowing generation of an object identifier is assigned to an object in Step S301. For example, a barcode is stuck to the object, a dot is described on the object, or a product number or a serial number is printed or marked on the object. Then, in Step S303, the object assigned with identification information allowing generation of an object identifier is shipped as a commodity.

Registration of ownership abandonment information at a point of sale will be described. In Step S311, a point of sale system (POS) terminal as a sale management terminal included in the sale management device 210 performs checkout processing of the object assigned with identification information allowing generation of an object identifier. Then, in Step S313, identification information for generation of an object identifier is acquired with a camera (or a barcode reader or the like) as a connected identification information input unit. In Step S315, the POS terminal generates an object identifier from the acquired identification information. Then, in Step S317, the POS terminal acquires information that ownership of a sold object is abandoned when the object is lost and then found, as a response to an inquiry to a customer. In Step S319, the POS terminal transmits the generated object identifier and the ownership abandonment information in association with each other to the found object management server 220. In Step S321, the found object management server 220 registers the received object identifier and the ownership abandonment information in association with each other into the found object management database 221.

Found object management in a case of a lost object being found and being brought into a found object office will be described. In the following description, a found object management device at the found object office 230 is denoted as a “found object management device 230” using the same reference sign as the reference sign of the found object office. In Step S331, a found object management terminal included in the found object management device 230 acquires identification information for object identifier generation with a camera (or a barcode reader or the like) as a connected identification information input unit. In Step S333, the found object management terminal generates an object identifier from the acquired identification information. Then, in Step S335, the found object management terminal transmits the generated object identifier to the found object management server 220. In Step S337, the found object management server 220 checks object identifiers by referring to the found object management database 221 and when matching object identifiers exist, acquires ownership abandonment information registered in association with the object identifier from the found object management database 221. Object identifiers may be determined to match when the difference between the two is within a predetermined threshold value. In Step S339, the found object management server 220 transmits the ownership abandonment information to the found object management terminal included in the found object management device 230. In Step S341, the found object management terminal notifies the ownership abandonment information to a handler at the found object office. In other words, the handler at the found object office or the finder can determine disposal of a found object ownership of which by an owner (purchaser) is abandoned by himself/herself without keeping the found object in a found object depository.

FIG. 3B is a sequence diagram illustrating another operation procedure of the found object management system 200 according to the present example embodiment. FIG. 3B is an operational sequence of the found object management system 200 assigning identification information allowing generation of an object identifier to an object, at a point of sale. In FIG. 3B, a step similar to that in FIG. 3A is given the same step number, and redundant description is omitted.

In FIG. 3B, a POS terminal included in the sale management device 210 performs checkout processing of an object in Step S311 at a point of sale of the object rather than in an object factory or in distribution before sale of the object and then assigns identification information allowing generation of an object identifier to the object in Step S312. For example, a barcode is stuck to the object, or a dot is described on the object. When identification information allowing generation of an object identifier is assigned to an object at a point of sale of the object, it is desirable that assignment of a dot allowing generation of an object identifier by a simple operation be performed.

While cases of generating an object identifier in the sale management device 210 and the found object management device 230 have been described in the sequences in aforementioned FIG. 3A and FIG. 3B, the found object management server 220 may be configured to generate an object identifier thus reducing loads on the sale management device 210 and the found object management device 230.

### Found Object Management Server

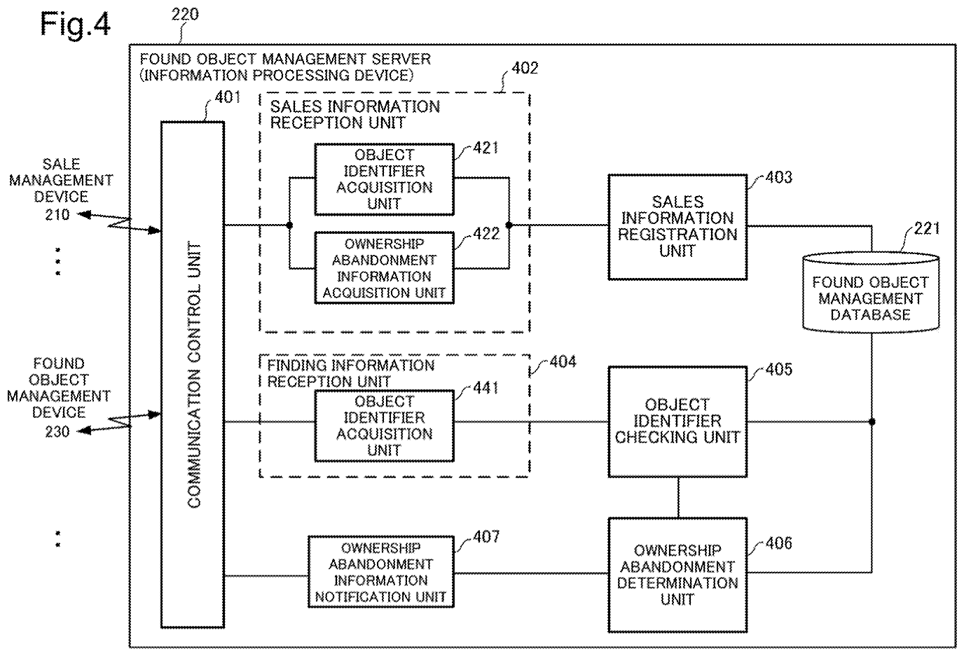

FIG. 4 is a block diagram illustrating a functional configuration of the found object management server 220 as the information processing device according to the present example embodiment.

The found object management server 220 includes a communication control unit 401, a sales information reception unit 402, a sales information registration unit 403, the found object management database 221, a finding information reception unit 404, an object identifier checking unit 405, an ownership abandonment determination unit 406, and an ownership abandonment information notification unit 407.

The communication control unit 401 controls communication with the sale management device 210 and the found object management device 230 through a network. The sales information reception unit 402 includes an object identifier acquisition unit 421 and an ownership abandonment information acquisition unit 422, and receives an object identifier and related ownership abandonment information that are transmitted from the sale management device 210 at a point of sale. The sales information registration unit 403 registers an object identifier and ownership abandonment information that are received by the sales information reception unit 402, in association with each other, into the found object management database 221. The found object management database 221 registers an object identifier and ownership abandonment information in association with each other, and the registered data are used for ownership abandonment of a found object.

The finding information reception unit 404 includes an object identifier acquisition unit 441 and receives an object identifier transmitted from the found object management device 230 during found object management. The object identifier checking unit 405 checks an object identifier received by the finding information reception unit 404 against an object identifier registered in the found object management database 221. Then, when matching object identifiers exist in a check result by the object identifier checking unit 405, the ownership abandonment determination unit 406 determines that ownership of an object with the object identifier transmitted from the found object management device 230 is abandoned. Object identifiers may be determined to match when the difference between the two is within a predetermined threshold value. The ownership abandonment information notification unit 407 notifies the found object management device 230 that ownership of the object with the object identifier transmitted from the found object management device 230 is abandoned.

### Found Object Management Database

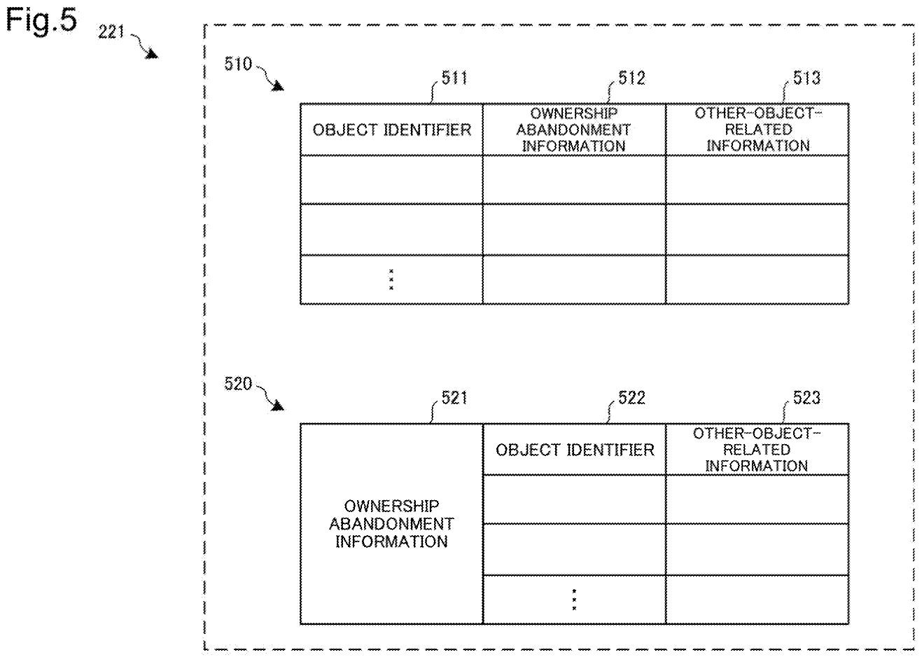

FIG. 5 is a diagram illustrating a structure of the found object management database 221 according to the present example embodiment. The found object management database 221 registers an object identifier of a sold object and information indicating abandonment of ownership in a case of the object being lost and then found, and is used for found object management.

A configuration 510, a configuration 520, and the like are registered in the found object management database 221. The configuration 510 stores ownership abandonment information 512 in association with an object identifier 511. Other-object-related information 513 may be further stored in association with an object identifier 511. For example, by limiting a checking range by storing a commodity name and/or the like as other-object-related information 513, identification precision and identification speed of an object may be increased.

The configuration 520 stores an object identifier 522 set with ownership abandonment information 521. Other-object-related information 523 may be further stored in association with an object identifier 522. For example, by limiting a checking range by storing a commodity name and/or the like as other-object-related information 523, identification precision and identification speed of an object may be increased.

While the present example embodiment is described under an assumption that ownership is abandoned when ownership abandonment information is set, the ownership abandonment information may indicate abandonment of ownership or maintenance of ownership, and a content of the ownership abandonment information may be further determined. Information included in the found object management database 221 is not limited to FIG. 5. Information useful for decreasing the number of kept found objects and speeding up disposal of the found objects, or making the found objects recycling-based may be added.

### Functional Configuration of Sale Management Device

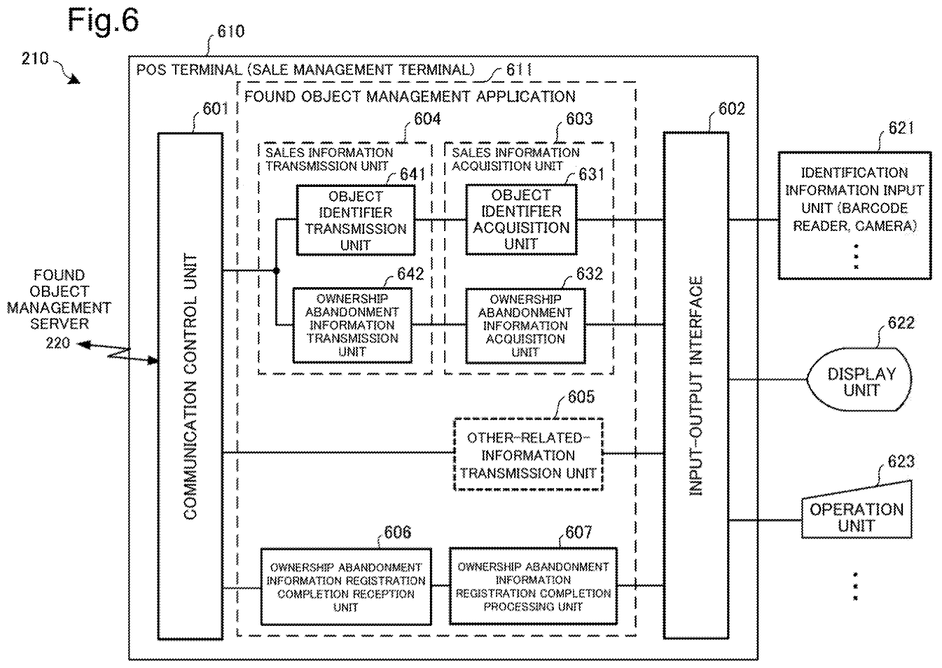

FIG. 6 is a block diagram illustrating a functional configuration of the sale management device 210 according to the present example embodiment.

The sale management device 210 includes a POS terminal 610 as a sale management terminal, an identification information input unit 621 to which information being a source of an object identifier is input, a display unit 622, and an operation unit 623. The identification information input unit 621 includes a barcode reader or a camera (a high-resolution camera such as a microcamera in a case of a dot identifier) depending on an object identifier to be used. The POS terminal 610 includes a communication control unit 601, an input-output interface 602, a sales information acquisition unit 603, a sales information transmission unit 604, an optional other-related-information transmission unit 605, an ownership abandonment information registration completion reception unit 606, and an ownership abandonment information registration completion processing unit 607. The identification information input unit 621, the display unit 622, and the operation unit 623 are connected to the input-output interface 602 in the POS terminal 610.

The communication control unit 601 controls communication with the found object management server 220 through a network. The input-output interface 602 serves as an interface with input-output equipment. The sales information acquisition unit 603 includes an object identifier acquisition unit 631 and an ownership abandonment information acquisition unit 632, and acquires an object identifier for identifying a sold object and ownership abandonment information related to the object identifier. The sales information transmission unit 604 includes an object identifier transmission unit 641 and an ownership abandonment information transmission unit 642, and transmits an object identifier and ownership abandonment information of a sold object in association with each other to the found object management server 220. The optional other-related-information transmission unit 605 acquires related information about a sold object at a point of sale and transmits the information to the found object management server 220. The ownership abandonment information registration completion reception unit 606 receives, from the found object management server 220, that an object identifier and ownership abandonment information are registered in association with each other into the found object management database 221. The ownership abandonment information registration completion processing unit 607 performs processing such as reporting completion of ownership abandonment information registration to the display unit 622.

In the POS terminal 610, the sales information acquisition unit 603, the sales information transmission unit 604, the optional other-related-information transmission unit 605, the ownership abandonment information registration completion reception unit 606, and the ownership abandonment information registration completion processing unit 607 may be included in a found object management application 611.

### Functional Configuration of Found Object Management Device

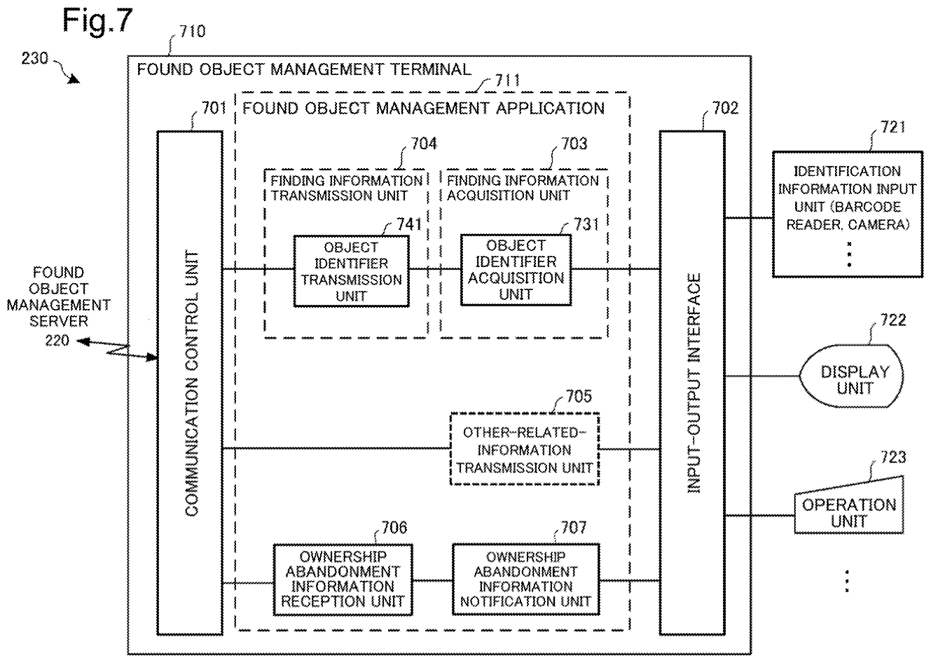

FIG. 7 is a block diagram illustrating a functional configuration of the found object management device 230 according to the present example embodiment.

The found object management device 230 includes a found object management terminal 710, an identification information input unit 721 to which information being a source of an object identifier is input, a display unit 722, and an operation unit 723. The identification information input unit 721 includes a barcode reader or a camera (a high-resolution camera such as a microcamera in a case of a dot identifier) depending on an object identifier to be used. The found object management terminal 710 includes a communication control unit 701, an input-output interface 702, a finding information acquisition unit 703, a finding information transmission unit 704, an optional other-related-information transmission unit 705, an ownership abandonment information reception unit 706, and an ownership abandonment information notification unit 707. The identification information input unit 721, the display unit 722, and the operation unit 723 are connected to the input-output interface 702 in the found object management terminal 710.

The communication control unit 701 controls communication with the found object management server 220 through a network. The input-output interface 702 serves as an interface with input-output equipment. The finding information acquisition unit 703 includes an object identifier acquisition unit 731 and acquires an object identifier of a found object. The finding information transmission unit 704 includes an object identifier transmission unit 741 and transmits an object identifier of a found object to the found object management server 220. The optional other-related-information transmission unit 705 acquires information related to a found object during found object management and transmits the information to the found object management server 220. The ownership abandonment information reception unit 706 receives, from the found object management server 220, that ownership of a found object is abandoned. The ownership abandonment information notification unit 707 performs processing such as reporting abandonment of ownership to the display unit 722.

In the found object management terminal 710, the finding information acquisition unit 703, the finding information transmission unit 704, the optional other-related-information transmission unit 705, the ownership abandonment information reception unit 706, and the ownership abandonment information notification unit 707 may be included in a found object management application 711.

### Hardware Configuration of Found Object Management Server

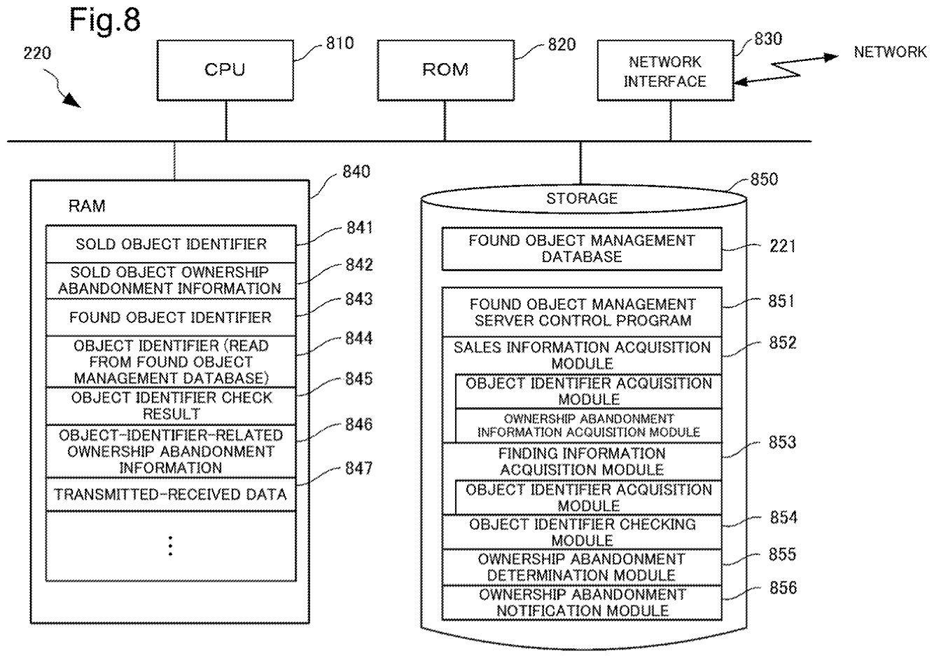

FIG. 8 is a block diagram illustrating a hardware configuration of the found object management server 220 as the information processing device according to the present example embodiment.

In FIG. 8, a central processing unit (CPU) 810 is a processor for arithmetic control and provides the function configuration units in FIG. 4 by executing a program. There may be one or a plurality of CPUs 810. A read only memory (ROM) 820 stores initial data, fixed data for a program and the like, and a program. A network interface 830 controls communication with the sale management device 210 and the found object management device 230 through a network.

A random access memory (RAM) 840 is a random access memory used by the CPU 810 as a work area for temporary storage. The RAM 840 secures a region for storing data required for providing the present example embodiment. A sold object identifier 841 is data of an object identifier of a sold object transmitted from the sale management device 210. Sold object ownership abandonment information 842 is data of ownership abandonment being transmitted from the sale management device 210 and being associated with an object identifier 841. A found object identifier 843 is data of an object identifier of a found object transmitted from the found object management device 230. An object identifier (read from the found object management database) 844 is data of an object identifier of a sold object being registered in and read from the found object management database 221. An object identifier check result 845 is data of a check result between a found object identifier 843 and an object identifier (read from the found object management database) 844, and indicates whether matching object identifiers exist. An object-identifier-related ownership abandonment information 846 is data of ownership abandonment associated with matching object identifiers when the object identifiers exist. Transmitted-received data 847 are data transmitted and received through the network interface 830 and include an object identifier and ownership abandonment information in this example. When collectively generating object identifiers, the found object management server 220 is configured to receive identification information for generating object identifiers from the sale management device 210 and the found object management device 230, and generates object identifiers from the identification information.

A storage 850 stores a database, various parameters, or the following data or programs required for providing the present example embodiment that are used by the CPU 810. As illustrated in FIG. 5, the found object management database 221 registers data associating an object identifier with ownership abandonment information. The storage 850 stores the following programs. A found object management server control program 851 is a program controlling the entire found object management server 220. A sales information acquisition module 852 is a module including an object identifier acquisition module and an ownership abandonment information acquisition module, acquiring information related to an object at a point of sale from the sale management device 210, and registering the information into the found object management database 221. A finding information acquisition module 853 is a module including an object identifier acquisition module and acquiring information related to an object during found object management from the found object management device 230. An object identifier checking module 854 is a module checking an object identifier found from the found object management device 230 against an object identifier registered in the found object management database 221. An ownership abandonment determination module 855 is a module determining, when matching object identifiers exist in a check result, abandonment of ownership from ownership abandonment information registered in association with the object identifier in the found object management database 221. An ownership abandonment notification module 856 is a module notifying, when ownership of a found object is determined to be abandoned, that ownership of the found object related to the object identifier is abandoned, to the found object management device 230.

When the found object management server 220 generates an object identifier, the storage 850 stores an object identifier generation algorithm and an object identifier generation module. A program and data related to a general-purpose function and other executable functions of the found object management server 220 are not illustrated in the RAM 840 and the storage 850 in FIG. 8.

### Processing Procedure in Found Object Management Server

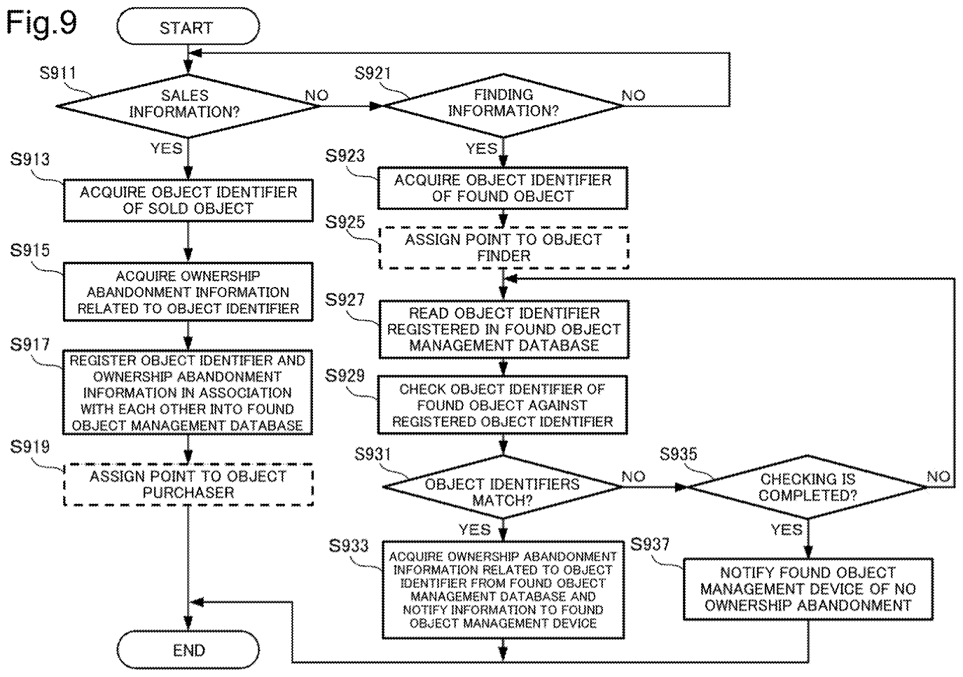

FIG. 9 is a flowchart illustrating a processing procedure in the found object management server 220 as the information processing device according to the present example embodiment. The flowchart is executed by the CPU 810 in FIG. 8 by use of the RAM 840 and provides the function configuration units in FIG. 4.

In Step S911, the found object management server 220 determines whether to receive sales information from the sale management device 210. When determining to receive sales information, the found object management server 220 acquires an object identifier of a sold object from the sales information transmitted from the sale management device 210 in Step S913. In Step S915, the found object management server 220 acquires ownership abandonment information associated with the object identifier from the sales information transmitted from the sale management device 210. Then, in Step S917, the found object management server 220 registers the acquired object identifier and ownership abandonment information in association with each other into the found object management database 221. It is desirable that, in Step S919, the found object management server 220 perform bonus information transmission such as assigning a point to a purchaser setting abandonment of ownership in a case of a purchased object being lost and then found.

When determining not to receive sales information, the found object management server 220 determines whether to receive finding information from the found object management device 230 in Step S921. When determining to receive finding information, the found object management server 220 acquires an object identifier of a found object from the finding information transmitted from the found object management device 230 in Step S923. It is desirable that, in Step S925, the found object management server 220 performs bonus information transmission such as assigning a point to the finder. In Step S927, the found object management server 220 reads an object identifier registered in the found object management database 221. Then, in Step S929, the found object management server 220 checks the object identifier of the found object from the found object management device 230 against the object identifier read from the found object management database 221. In Step S931, the found object management server 220 determines whether the object identifiers match from the check result. Object identifiers may be determined to match when the difference between the two is within a predetermined threshold value. When the object identifiers match, the found object management server 220 acquires ownership abandonment information related to the matching object identifiers from the found object management database 221 and notifies the found object management device 230 that ownership of the found object is abandoned, in Step S933. On the other hand, when the object identifiers do not match, the found object management server 220 determines whether checking of object identifiers is completed, in Step S935. When determining that checking of object identifiers is not completed, the found object management server 220 returns to Step S927, reads a next object identifier from the found object management database 221, and performs checking. When determining that checking of object identifiers is completed, the found object management server 220 notifies the found object management device 230 of no ownership abandonment of the found object (ownership maintenance) in Step S937.

### Hardware Configuration of Sale Management Device

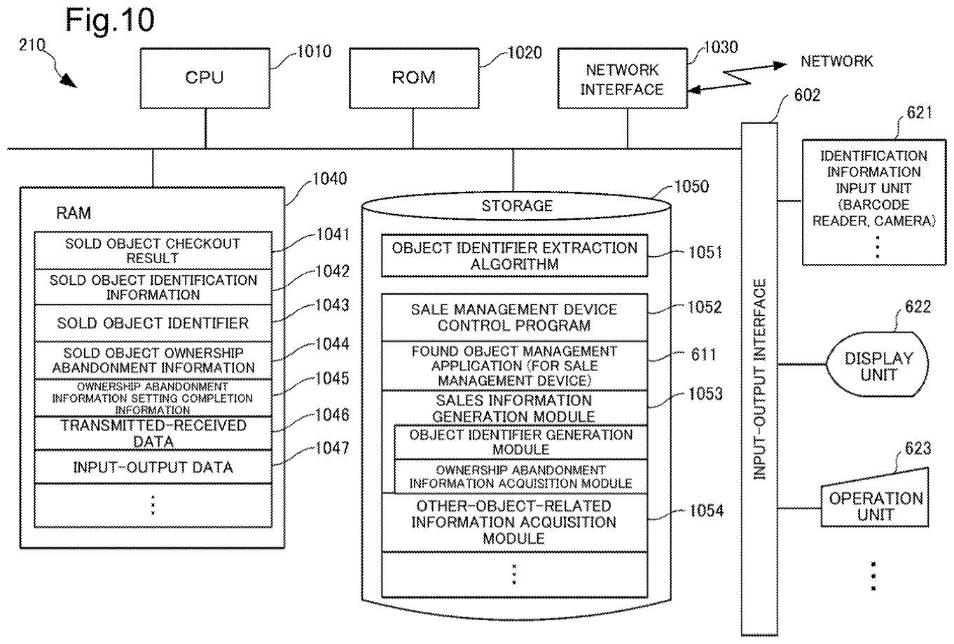

FIG. 10 is a block diagram illustrating a hardware configuration of the sale management device 210 according to the present example embodiment.

In FIG. 10, a CPU 1010 is a processor for arithmetic control and provides the function configuration units in FIG. 6 by executing a program. There may be one or a plurality of CPUs 1010. A ROM 1020 stores initial data, fixed data for a program and the like, and a program. A network interface 1030 controls communication with the found object management server 220 through a network.

A RAM 1040 is a random access memory used by the CPU 1010 as a work area for temporary storage. The RAM 1040 secures a region for storing data required for providing the present example embodiment. A sold object checkout result 1041 is data indicating a checkout of a sold object by the sale management device 210. Sold object identification information 1042 is data for object identification on a sold object input from the identification information input unit 621. A sold object identifier 1043 is data of an object identifier generated based on identification information 1042. Sold object ownership abandonment information 1044 is ownership abandonment data set in association with a sold object identifier 1043. Ownership abandonment information setting completion information 1045 is data indicating completion of registration of ownership abandonment information into the found object management database 221, the data being notified from the found object management server 220. Transmitted-received data 1046 store data transmitted and received through the network and include an object identifier, ownership abandonment information, and ownership abandonment information setting completion information, in this example. Input-output data 1047 are data input and output from and to input-output equipment through the input-output interface 602.

A storage 1050 stores a database, various parameters, or the following data or programs required for providing the present example embodiment that are used by the CPU 1010. An object identifier extraction algorithm 1051 is an object identifier extraction algorithm used by the sale management device 210 for performing an object identifier generation function. The storage 1050 stores the following programs. A sale management device control program 1052 is a program controlling the entire sale management device 210. A found object management application (for a sale management device) 611 is an application program for performing found object management as the sale management device 210 and includes the following modules. A sales information generation module 1053 includes an object identifier generation module generating an object identifier from identification information acquired from a sold object and an ownership abandonment information acquisition module acquiring ownership abandonment information related to the object identifier. An other-object-related information acquisition module 1054 is a module acquiring other related information required for management of a sold object in the present example embodiment.

The input-output interface 602 serves as an interface for controlling data input and output from and to an input-output device. As illustrated in FIG. 6, the input-output interface 602 according to the present example embodiment is connected to the identification information input unit 621 such as a barcode reader or a camera, the display unit 622, the operation unit 623, and the like.

A program and data related to a general-purpose function and other executable functions of the sale management device 210 such as a POS are not illustrated in the RAM 1040 and the storage 1050 in FIG. 10.

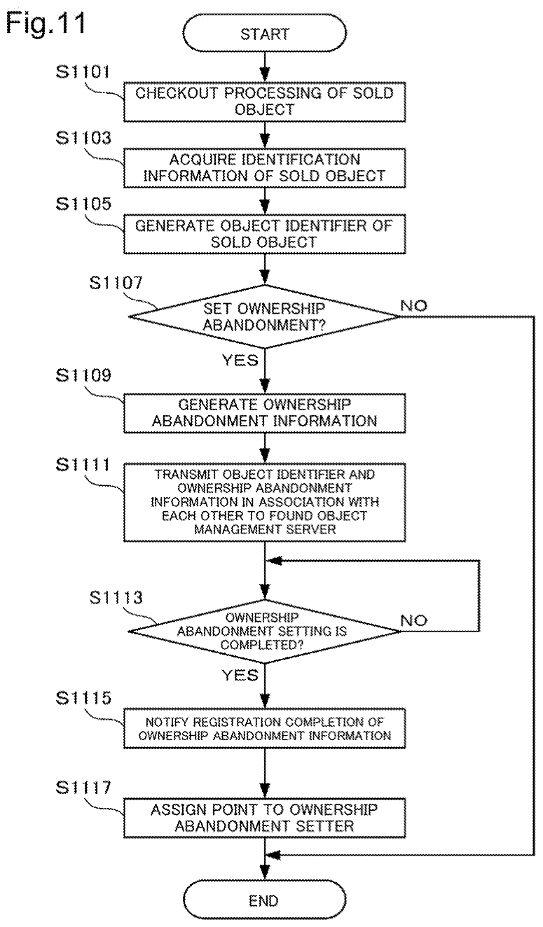

Processing Procedure in Sale Management Device FIG. 11 is a flowchart illustrating a processing procedure in the sale management device 210 according to the present example embodiment. The flowchart is executed by the CPU 1010 in FIG. 10 by use of the RAM 1040 and provides the function configuration units in FIG. 6.

In Step S1101, the sale management device 210 performs checkout processing of a sold object. In Step S1103, the sale management device 210 acquires, from the sold object, identification information for generating an object identifier. Then, in Step S1105, the sale management device 210 generates an object identifier from the identification information.

Next, in Step S1107, the sale management device 210 inquires of the purchaser of the sold object about whether to abandon ownership of the sold object when the sold object is lost and then found, and determines the response result. When the response indicates abandonment of ownership, the sale management device 210 generates ownership abandonment information in Step S1109. In Step S1111, the sale management device 210 transmits the object identifier and the ownership abandonment information in association with each other to the found object management server 220. Then, in Step S1113, the sale management device 210 awaits a setting completion notification of ownership abandonment from the found object management server 220.

When receiving a setting completion notification of ownership abandonment from the found object management server 220, the sale management device 210 notifies registration completion of ownership abandonment information by display or the like in Step S1115. Then, in Step S1117, the sale management device 210 gives a bonus such as a point to the purchaser setting ownership abandonment of the sold object.

On the other hand, when the response indicates that ownership is not abandoned in Step S1107, the processing ends.

When the sale management device 210 does not have an object identifier extraction function, the sale management device 210 does not perform generation of an object identifier in Step S1105 and transmits identification information allowing generation of an object identifier instead of an object identifier to the found object management server 220 along with ownership abandonment information in Step S1111.

### Hardware Configuration of Found Object Management Device

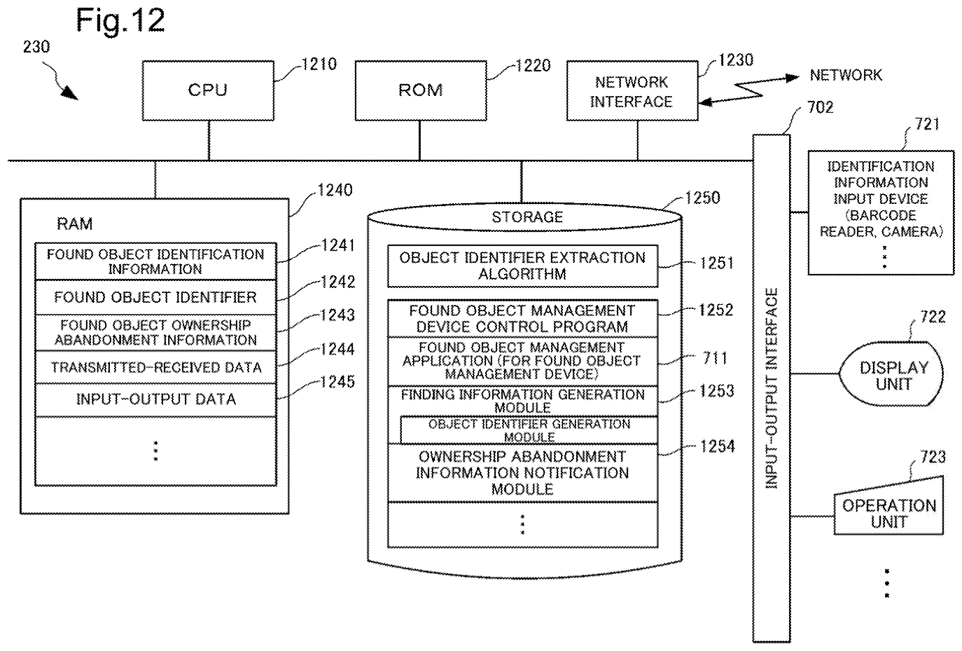

FIG. 12 is a block diagram illustrating a hardware configuration of the found object management device 230 according to the present example embodiment.

In FIG. 12, a CPU 1210 is a processor for arithmetic control and provides the function configuration units in FIG. 7 by executing a program. There may be one or a plurality of CPUs 1210. A ROM 1220 stores initial data, fixed data for a program and the like, and a program. A network interface 1230 controls communication with the found object management server 220 through a network.

A RAM 1240 is a random access memory used by the CPU 1210 as a work area for temporary storage. The RAM 1240 secures a region for storing data required for providing the present example embodiment. Found object identification information 1241 is data for object identification on a found object input from the identification information input unit 721. A found object identifier 1242 is data of an object identifier generated based on identification information 1241. Found object ownership abandonment information 1243 is data of ownership abandonment registered in the found object management database 221 in the found object management server 220, in association with an object identifier of a sold object matching a found object identifier 1242. Transmitted-received data 1244 store data transmitted and received through the network and include an object identifier and ownership abandonment information in this example. Input-output data 1245 are data input and output from and to input-output equipment through the input-output interface 602.

A storage 1250 stores a database, various parameters, or the following data or programs required for providing the present example embodiment that are used by the CPU 1210. An object identifier extraction algorithm 1251 is an object identifier extraction algorithm used by the found object management device 230 for performing the object identifier generation function. The storage 1250 stores the following programs. A found object management device control program 1252 is a program controlling the entire found object management device 230. A found object management application (for a found object management device) 711 is an application program for performing found object management as the found object management device 230 and includes the following modules. A finding information generation module 1253 includes an object identifier generation module generating an object identifier from identification information acquired from a found object. An ownership abandonment information notification module 1254 is a module receiving ownership abandonment information registered in the found object management database 221 in association with an object identifier matching an object identifier generated by the object identifier generation module, and notifying that ownership of a found object is abandoned.

The input-output interface 702 serves as an interface controlling data input and output from and to an input-output device. As illustrated in FIG. 7, the input-output interface 702 according to the present example embodiment is connected to the identification information input unit 721 such as a barcode reader or a camera, the display unit 722, the operation unit 723, and the like.

A program and data related to a general-purpose function and other executable functions of the found object management device 230 such as a PC are not illustrated in the RAM 1240 and the storage 1250 in FIG. 12.

### Processing Procedure in Found Object Management Device

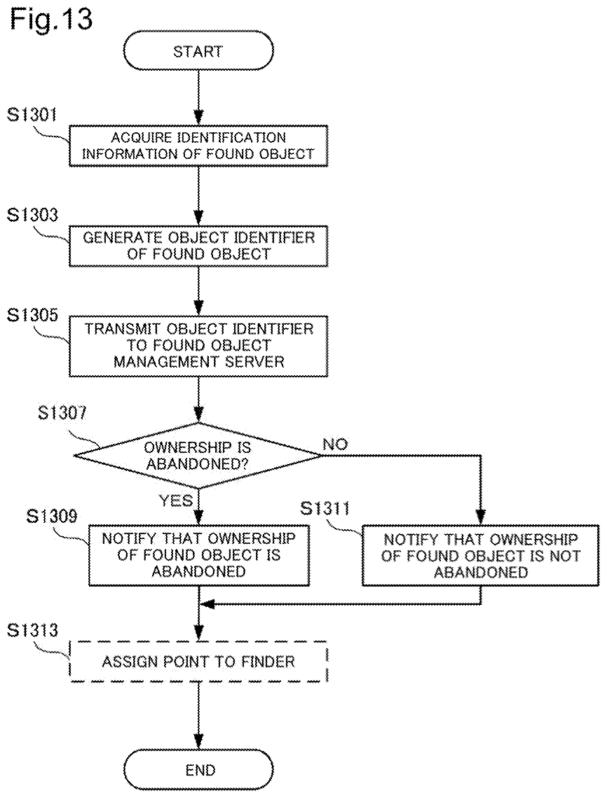

FIG. 13 is a flowchart illustrating a processing procedure in the found object management device 230 according to the present example embodiment. The flowchart is executed by the CPU 1210 in FIG. 12 by use of the RAM 1240 and provides the function configuration units in FIG. 7.

In Step S1301, the found object management device 230 acquires, from a found object, identification information for generating an object identifier. In Step S1303, the found object management device 230 generates an object identifier from the identification information. Then, in Step S1305, the found object management device 230 transmits the generated object identifier to the found object management server 220.

Next, in Step S1307, the found object management device 230 awaits, from the found object management server 220, ownership abandonment information set to an object identifier matching the object identifier of the found object. When there is a response that ownership of the found object is abandoned by the purchaser, the found object management device 230 notifies that the ownership of the found object is abandoned by the purchaser, in Step S1309. On the other hand, when there is a response that ownership of the found object is not abandoned by the purchaser, the found object management device 230 notifies that the ownership of the found object is not abandoned by the purchaser, in Step S1311.

It is desirable that the found object management device 230 gives a bonus such as a point to the finder in Step S1313.

According to the present example embodiment, ownership abandonment information indicating that ownership of a sold object is abandoned in a case of the purchaser losing the sold object is set at the point of sale, and therefore time and expense for managing a found object can be reduced. Specifically, disposal of a found object ownership of which is abandoned becomes easier at a found object office or the like. Accordingly, time and expense for locating the owner of a found object being brought in in order to return the object to the owner or time and expense for keeping a found object until the owner is located can be reduced. Furthermore, a waste of resources by keeping a found object unused at a found object depository for a predetermined period can be eliminated.

### Third Example Embodiment

Next, a found object management system according to a third example embodiment of the present disclosure will be described. Compared with the aforementioned second example embodiment, the found object management system according to the present example embodiment differs in that when an owner losing a found object abandons ownership, a transfer destination where the found object is to be transferred can be further set. The remaining configuration and operation are similar to those of the second example embodiment, and therefore the same configurations and operations are respectively given the same reference signs, and detailed description thereof is omitted.

### Found Object Management System

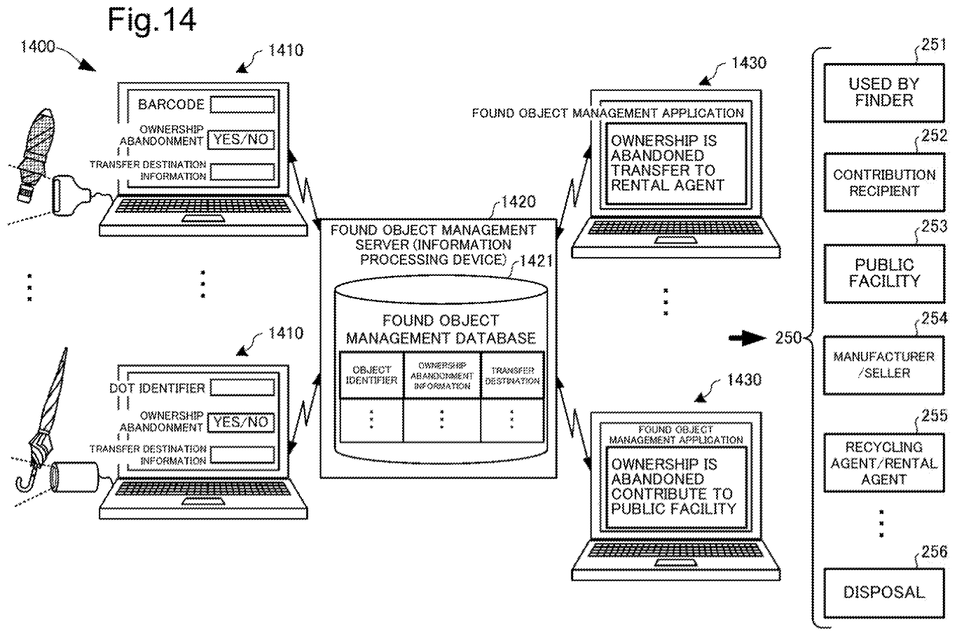

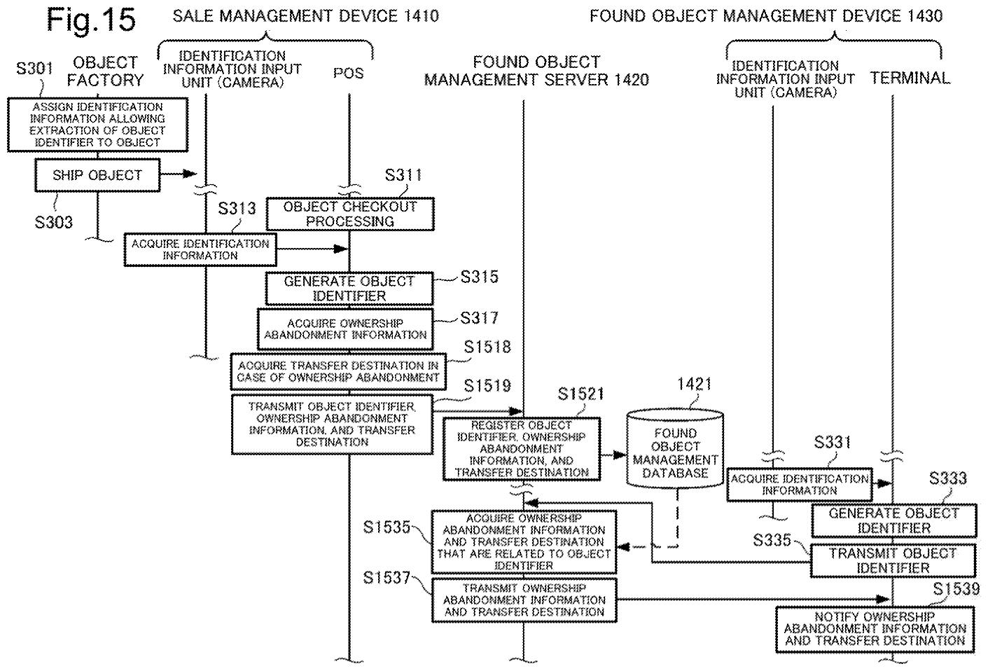

A configuration and an operation of the found object management system 1400 according to the present example embodiment will be described with reference to FIG. 14 and FIG. 15.

### Outline

FIG. 14 is a diagram illustrating an outline of the found object management system 1400 according to the present example embodiment. A component similar to that in FIG. 2A is given the same reference number, and redundant description is omitted.

A sale management device 1410 in the found object management system 1400 registers ownership abandonment information indicating whether ownership is abandoned when a sold object is lost and then found, and also a transfer destination of the sold object in a case of ownership abandonment, in association with an object identifier of the sold object, into a found object management database 1421 in a found object management server 1420.

On the other hand, a found object management device 1430 in the found object management system 1400 acquires identification information from a found object, generates an object identifier from the identification information, and transmits the object identifier to the found object management server 1420. When an object identifier matching an object identifier of a found object exists in the found object management database 1421, the found object management server 1420 determines abandonment of ownership from ownership abandonment information associated with the object identifier. Then, when the ownership is abandoned, the found object management server 1420 acquires a transfer destination of the found object associated with the object identifier and instructs transfer to the transfer destination.

For example, an instruction “OWNERSHIP IS ABANDONED. TRANSFER TO RENTAL AGENT.” and an example such as “OWNERSHIP IS ABANDONED. CONTRIBUTE TO PUBLIC FACILITY.” are illustrated in the found object management devices 1430 in FIG. 14.

### Operational Sequence

FIG. 15 is a sequence diagram illustrating an operation procedure of the found object management system 1400 according to the present example embodiment. FIG. 15 is an operational sequence of the found object management system 1400 assigning identification information allowing generation of an object identifier in a factory (manufacturing plant) of an object or in distribution, at or before sale of the object. In FIG. 15, a step similar to that in FIG. 3A is given the same step number, and redundant description is omitted.

In a case of ownership being abandoned when a sold object is lost and then found, a POS terminal included in the sale management device 1410 acquires a transfer destination of the sold object in Step S1518. Then, in Step S1519, the POS terminal transmits the generated object identifier of the sold object, and the ownership abandonment information and the transfer destination that are acquired in relation to the object identifier to the found object management server 1420. In Step S1521, the found object management server 1420 registers the object identifier, the ownership abandonment information, and the transfer destination that are received from the POS terminal into the found object management database 1421 in association with one another.

On the other hand, when receiving the object identifier of the found object from a terminal included in the found object management device 1430, the found object management server 1420 acquires, from the found object management database 1421, ownership abandonment information and a transfer destination that are related to an object identifier matching the object identifier of the found object, in Step S1535. Then, in Step S1537, the found object management server 1420 transmits the ownership abandonment information and the transfer destination to the terminal in the found object management device 1430. In Step S1539, the terminal in the found object management device 1430 notifies that ownership of the found object is abandoned and the transfer destination of the found object. Thus, without keeping, in a found object depository, a found object ownership of which by the owner (purchaser) is abandoned, a handler at a found object office or a finder can further determine transfer of the object to a transfer destination desired by the owner.

### Functional Configuration of Found Object Management Server

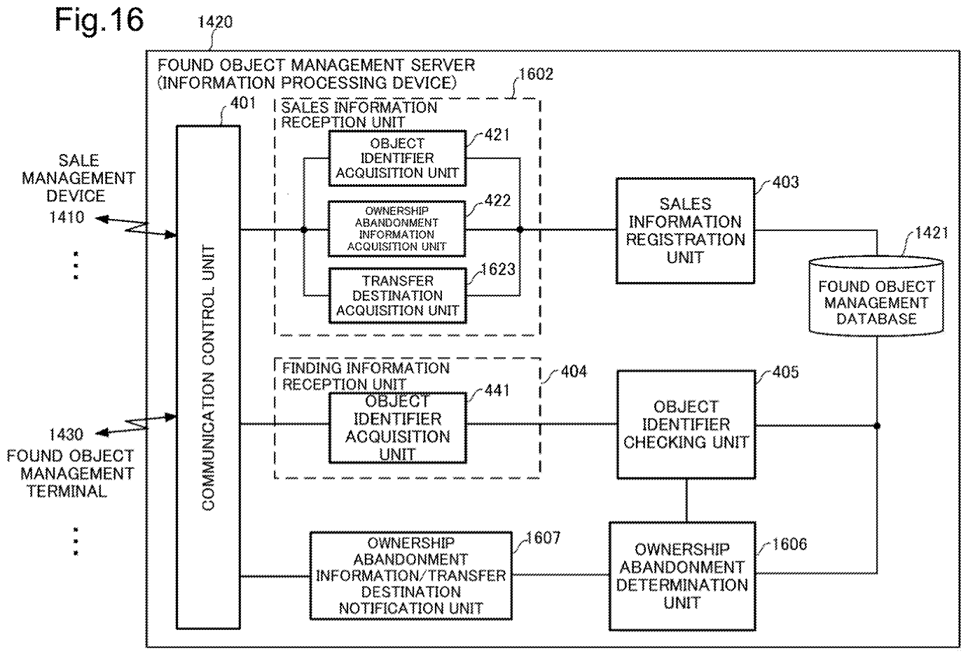

FIG. 16 is a block diagram illustrating a functional configuration of the found object management server 1420 as an information processing device according to the present example embodiment. In FIG. 16, a function configuration unit similar to that in FIG. 4 is given the same reference number, and redundant description is omitted.

A transfer destination acquisition unit 1623 included in a sales information reception unit 1602 acquires, from the sale management device 1410, a transfer destination after ownership is abandoned, the transfer destination being related to an object identifier of a sold object. Then, the found object management database 1421 registers ownership abandonment information and also the transfer destination, in association with the object identifier of the sold object.

When determining that ownership abandonment determination information is registered in the found object management database 1421 in relation to an object identifier matching an object identifier of a found object received from the found object management device 1430 and ownership is abandoned, an ownership abandonment determination unit 1606 acquires a transfer destination. An ownership abandonment information/destination storage notification unit 1607 notifies the found object management device 1430 of ownership abandonment information and a transfer destination of a found object about which an inquiry is made.

### Found Object Management Database

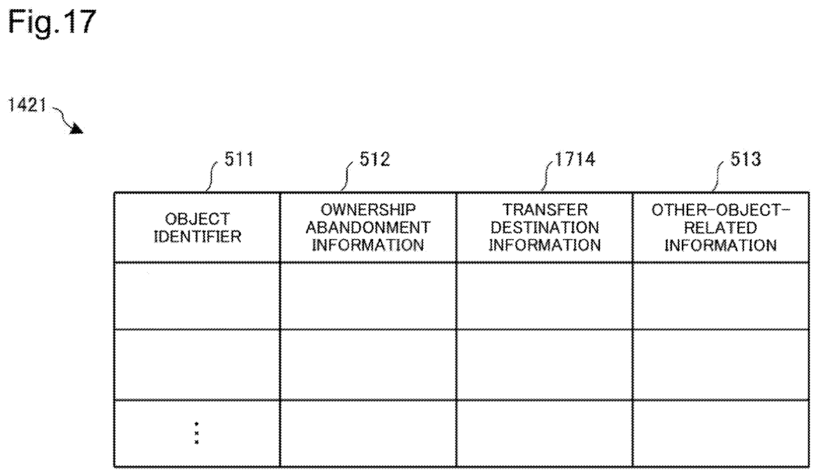

FIG. 17 is a diagram illustrating a structure of the found object management database 1421 according to the present example embodiment. The found object management database 1421 registers an object identifier of a sold object, ownership abandonment information, and a transfer destination, and is used for management of a found object. In FIG. 17, a component similar to that in FIG. 5 is given the same reference number, and redundant description is omitted.

The found object management database 1421 registers transfer destination information 1714 indicating a transfer destination in a case of ownership abandonment, in association with an object identifier 511 of a sold object.

While the present example embodiment is described under an assumption that ownership is abandoned when ownership abandonment information is set, the ownership abandonment information may indicate abandonment of ownership or maintenance of ownership, and a content of the ownership abandonment information may be further determined. Information included in the found object management database 221 is not limited to FIG. 17. Information useful for decreasing the number of kept found objects and speeding up disposal of the found objects, or making the found objects recycling-based may be added.

### Processing Procedure in Found Object Management Server

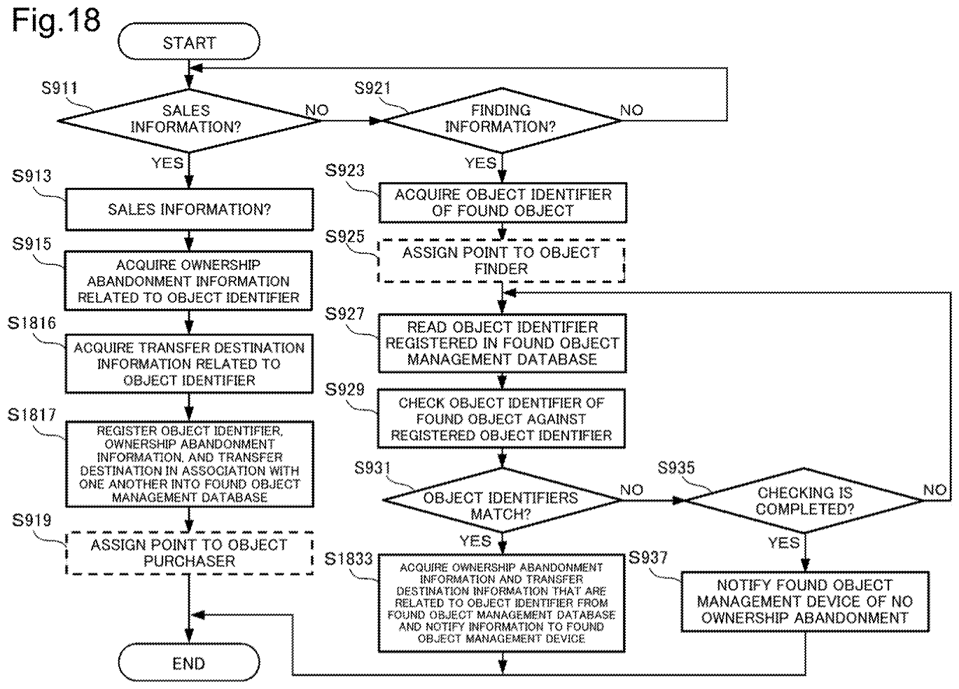

FIG. 18 is a flowchart illustrating a processing procedure in the found object management server 1420 as the information processing device according to the present example embodiment. The flowchart is executed by the CPU 810 in FIG. 8 by use of the RAM 840 and provides the function configuration units in FIG. 16.

When accessed from the sale management device 1410, the found object management server 1420 acquires transfer destination information related to the object identifier in a case of ownership abandonment from the sale management device 1410 in Step S1816. Then, in Step S1817, the found object management server 1420 registers the object identifier of the sold object, the ownership abandonment information, and the transfer destination information in association with one another into the found object management database 1421.

On the other hand, when accessed from the found object management device 1430, the found object management server 1420 acquires ownership abandonment information and transfer destination information that are associated with the object identifier of the found object from the found object management database 1421 and notifies the information to the found object management device 1430, in Step S1833.

### Functional Configuration of Sale Management Device

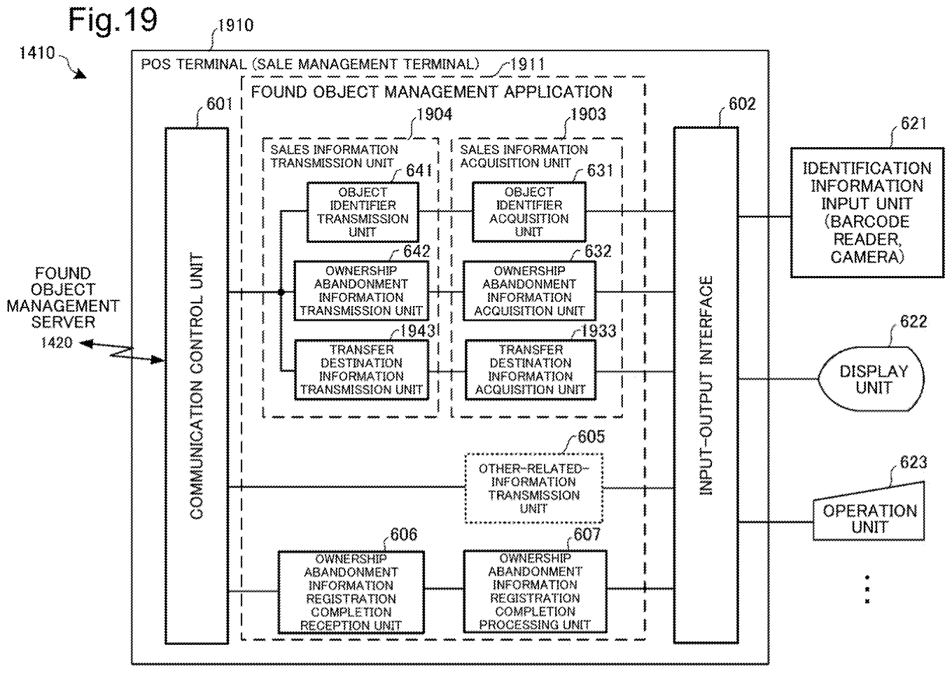

FIG. 19 is a block diagram illustrating a functional configuration of the sale management device 1410 according to the present example embodiment. In FIG. 19, a function configuration unit similar to that in FIG. 6 is given the same reference number, and redundant description is omitted.

The sale management device 1410 includes a POS terminal 1910 as a sale management terminal, an identification information input unit 621 to which information being a source of an object identifier is input, a display unit 622, and an operation unit 623. The POS terminal 1910 includes a communication control unit 601, an input-output interface 602, a sales information acquisition unit 1903, a sales information transmission unit 1904, an optional other-related-information transmission unit 605, an ownership abandonment information registration completion reception unit 606, and an ownership abandonment information registration completion processing unit 607.

The sales information acquisition unit 1903 includes an object identifier acquisition unit 631, an ownership abandonment information acquisition unit 632, and a transfer destination information acquisition unit 1933, and acquires an object identifier for identifying a sold object, ownership abandonment information related to the object identifier, and a transfer destination information in a case of ownership abandonment. The sales information transmission unit 1904 includes an object identifier transmission unit 641, an ownership abandonment information transmission unit 642, and a transfer destination information transmission unit 1943, and transmits an object identifier of a sold object, ownership abandonment information, and transfer destination information in association with one another to the found object management server 1420.

In the POS terminal 610, the sales information acquisition unit 1903, the sales information transmission unit 1904, the optional other-related-information transmission unit 605, the ownership abandonment information registration completion reception unit 606, and the ownership abandonment information registration completion processing unit 607 may be included in a found object management application 1911.

### Processing Procedure in Sale Management Device

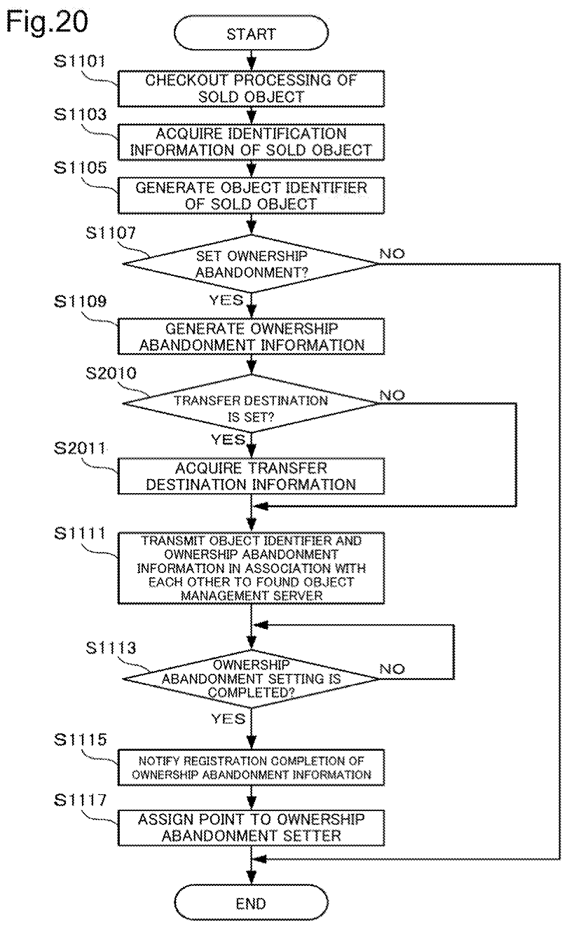

FIG. 20 is a flowchart illustrating a processing procedure in the sale management device 1410 according to the present example embodiment. In FIG. 20, a step similar to that in FIG. 11 is given the same step number, and redundant description is omitted.

In Step S2010, the sale management device 1410 determines whether a transfer destination is set when abandonment of ownership is set. When a transfer destination is set, the sale management device 1410 acquires transfer destination information through the operation unit 623 in Step S2011.

### Functional Configuration of Found Object Management Device

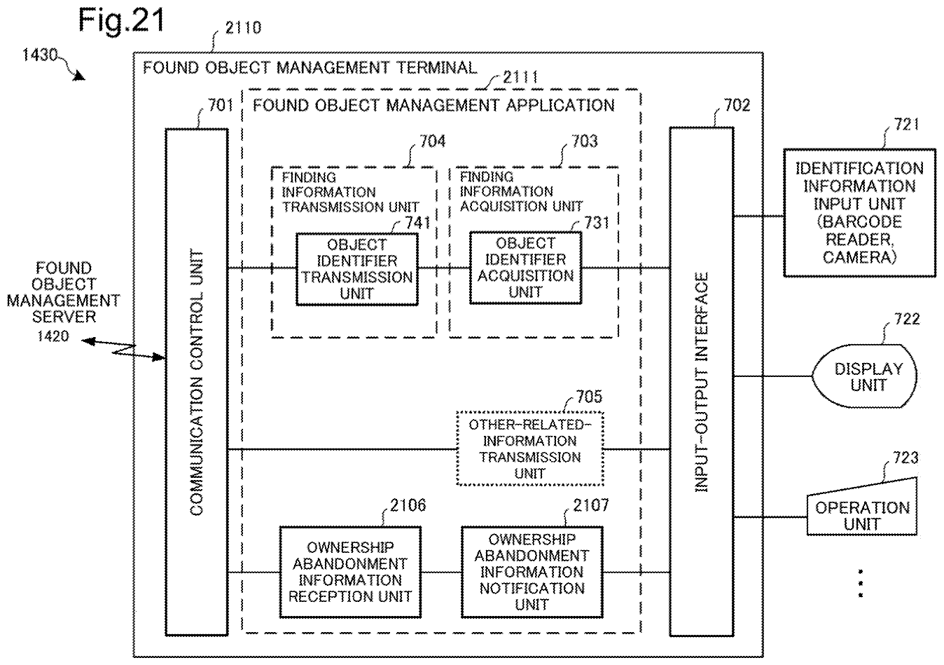

FIG. 21 is a block diagram illustrating a functional configuration of the found object management device 1430 according to the present example embodiment. In FIG. 21, a function configuration unit similar to that in FIG. 7 is given the same reference number, and redundant description is omitted.

The found object management device 1430 includes a found object management terminal 2110, an identification information input unit 721 to which information being a source of an object identifier is input, a display unit 722, and an operation unit 723. The found object management terminal 2110 includes a communication control unit 701, an input-output interface 702, a finding information acquisition unit 703, a finding information transmission unit 704, an optional other-related-information transmission unit 705, an ownership abandonment information reception unit 2106, and an ownership abandonment information notification unit 2107.

The ownership abandonment information reception unit 2106 receives, from the found object management server 1420, that ownership of a found object is abandoned and a transfer destination of the found object. The ownership abandonment information notification unit 2107 performs processing such as reporting ownership abandonment and a transfer destination to the display unit 722.

In the found object management terminal 2110, the finding information acquisition unit 703, the finding information transmission unit 704, the optional other-related-information transmission unit 705, the ownership abandonment information reception unit 2106, and the ownership abandonment information notification unit 2107 may be included in a found object management application 2111.

### Processing Procedure in Found Object Management Device

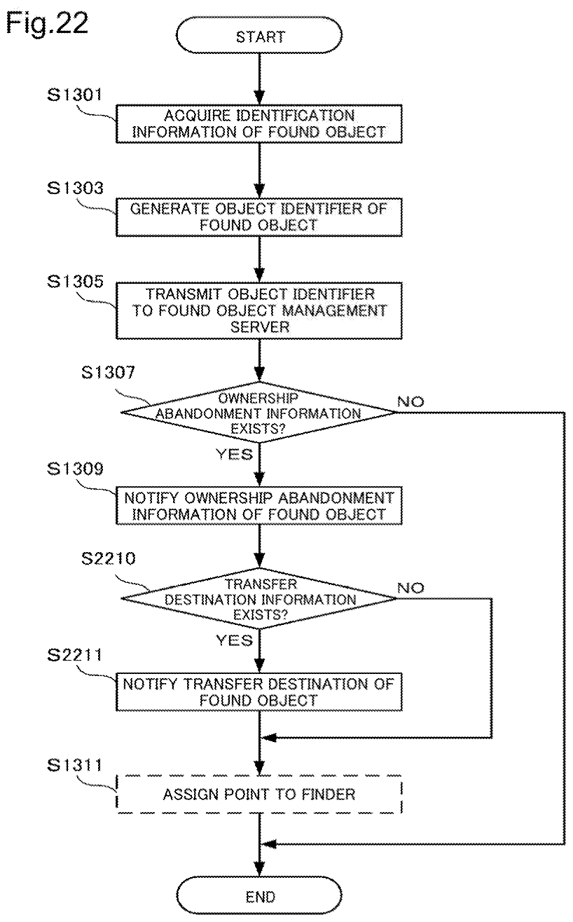

FIG. 22 is a flowchart illustrating a processing procedure in the found object management device 1430 according to the example embodiment. In FIG. 22, a step similar to that in FIG. 13 is given the same step number, and redundant description is omitted.

In Step S2210, the found object management device 1430 determines whether a response to an inquiry from the found object management server 1420 includes transfer destination information of the found object. When transfer destination information of the found object is included, the found object management device 1430 notifies the transfer destination of the found object by display or the like in Step S2211.

According to the present example embodiment, in addition to the effects of the aforementioned example embodiments, a loser not only abandons ownership of a found object but also instructs a desired transfer destination, and therefore time and expense of found object management can be further reduced. Specifically, a handler at a found object office or a finder can further determine transfer of a found object ownership of which by the owner (purchaser) is abandoned to a transfer destination desired by the owner, without keeping the found object in a found object depository. Consequently, a waste of resources can be further reduced by eliminating time for determination of a transfer destination and further speeding up recycling and sharing of resources.

### Fourth Example Embodiment

Next, a found object management system according to a fourth example embodiment of the present disclosure will be described. Compared with the aforementioned second example embodiment and third example embodiment, the found object management system according to the present example embodiment differs in that a purchaser of a sold object manages a date and time at which ownership is abandoned. The remaining configuration and operation are similar to those of the second example embodiment or the third example embodiment, and therefore the same configurations and operations are respectively given the same reference signs, and detailed description thereof is omitted.

### Operational Sequence of Found Object Management System

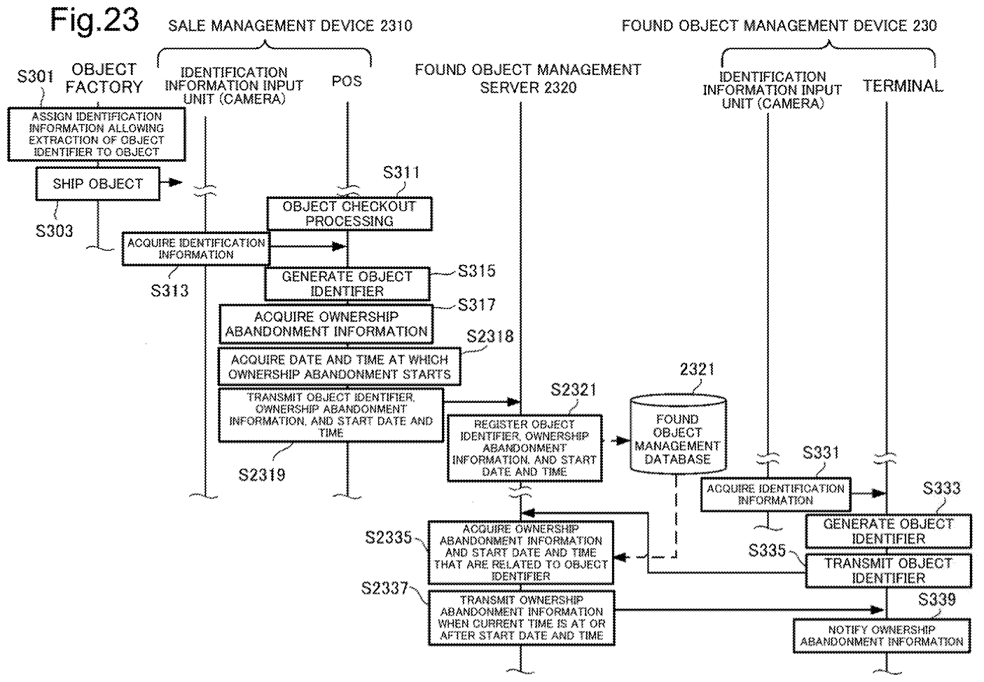

FIG. 23 is a sequence diagram illustrating an operation procedure of the found object management system according to the present example embodiment. In FIG. 23, a step similar to that in FIG. 3A is given the same step number, and redundant description is omitted.

In a case of ownership being abandoned when a sold object is lost and then found, a POS terminal included in a sale management device 2310 acquires a date and time at which ownership abandonment starts, in Step S2318. The date and time at which ownership abandonment starts may be set by a period after a date and time of loss, a period after a date and time of finding, or the like. Then, in Step S2319, the POS terminal transmits the generated object identifier of the sold object, the ownership abandonment information acquired in relation to the object identifier, and the start date and time to a found object management server 2320. In Step S2321, the found object management server 2320 registers the object identifier, the ownership abandonment information, and the start date and time that are received from the POS terminal into a found object management database 2321 in association with one another.

On the other hand, when receiving an object identifier of a found object from a terminal included in a found object management device 230, the found object management server 2320 acquires ownership abandonment information and a start date and time that are related to an object identifier matching the object identifier of the found object from a found object management database 2321 in Step S2335. Then, when the current time is at or after the start date and time of ownership abandonment, the found object management server 2320 transmits the ownership abandonment information to the terminal in the found object management device 230 in Step S2337. Thus, a handler at a found object office or a finder can limit a period in which a found object ownership of which by the owner (purchaser) is abandoned is kept in a found object depository.

### Functional Configuration of Found Object Management Server

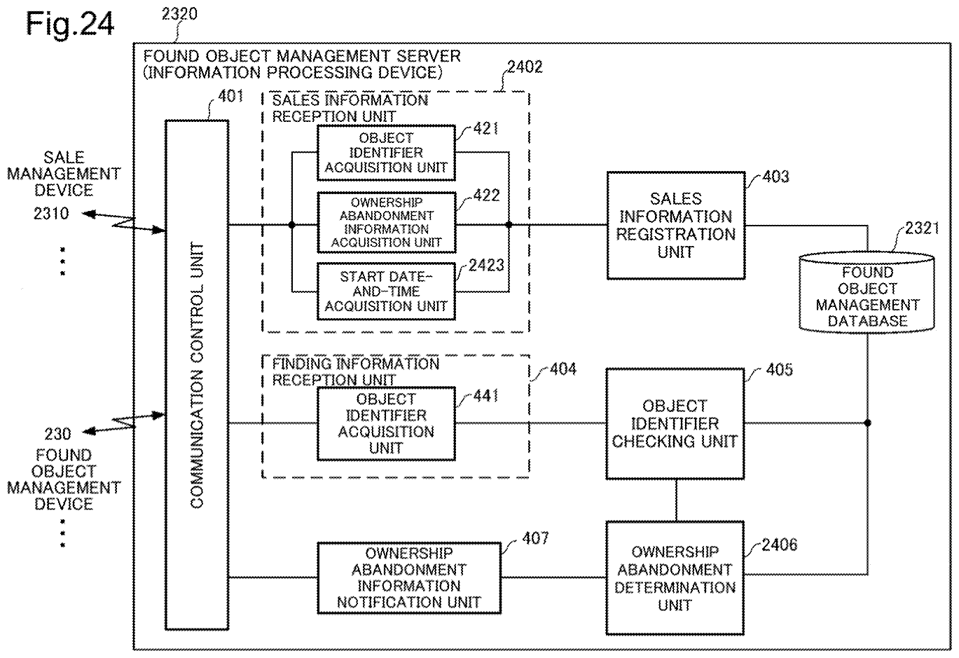

FIG. 24 is a block diagram illustrating a functional configuration of the found object management server 2320 as an information processing device according to the present example embodiment. In FIG. 24, a function configuration unit the same as that in FIG. 4 is given the same reference number, and redundant description is omitted.

A start date-and-time acquisition unit 2423 included in a sales information reception unit 2402 acquires date and time information indicating when abandonment of ownership related to an object identifier of a sold object starts from a sale management device 1410. Then, the found object management database 2321 registers the ownership abandonment information and also the start date and time, in association with the object identifier of the sold object.

When determining that ownership abandonment determination information is registered in the found object management database 2321 in relation to an object identifier matching an object identifier of a found object received from the found object management device 230 and ownership is to be abandoned, an ownership abandonment determination unit 2406 acquires start date-and-time information. Then, when the current time is at or after the start date and time, the ownership abandonment determination unit 2406 determines that the ownership is abandoned and instructs an ownership abandonment information notification unit 407 to notify the ownership abandonment.

### Found Object Management Database

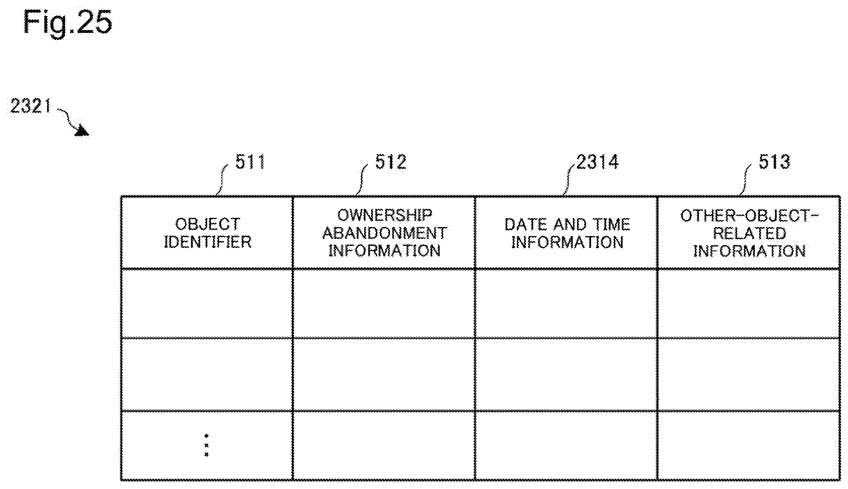

FIG. 25 is a diagram illustrating a structure of the found object management database 2321 according to the present example embodiment. The found object management database 2321 registers an object identifier of a sold object, ownership abandonment information, and a start date and time, and is used for management of a found object. In FIG. 25, a component similar to that in FIG. 5 is given the same reference number, and redundant description is omitted.

The found object management database 2321 registers date and time information 2314 indicating when abandonment of ownership starts, in association with an object identifier 511 of a sold object.

While the present example embodiment is described under an assumption that ownership is abandoned when ownership abandonment information is set, the ownership abandonment information may indicate abandonment of ownership or maintenance of ownership, and a content of the ownership abandonment information may be further determined. Information included in the found object management database 2321 is not limited to FIG. 25. Information useful for decreasing the number of kept found objects and speeding up disposal of the found objects, or making the found objects recycling-based may be added.

### Processing Procedure in Found Object Management Server

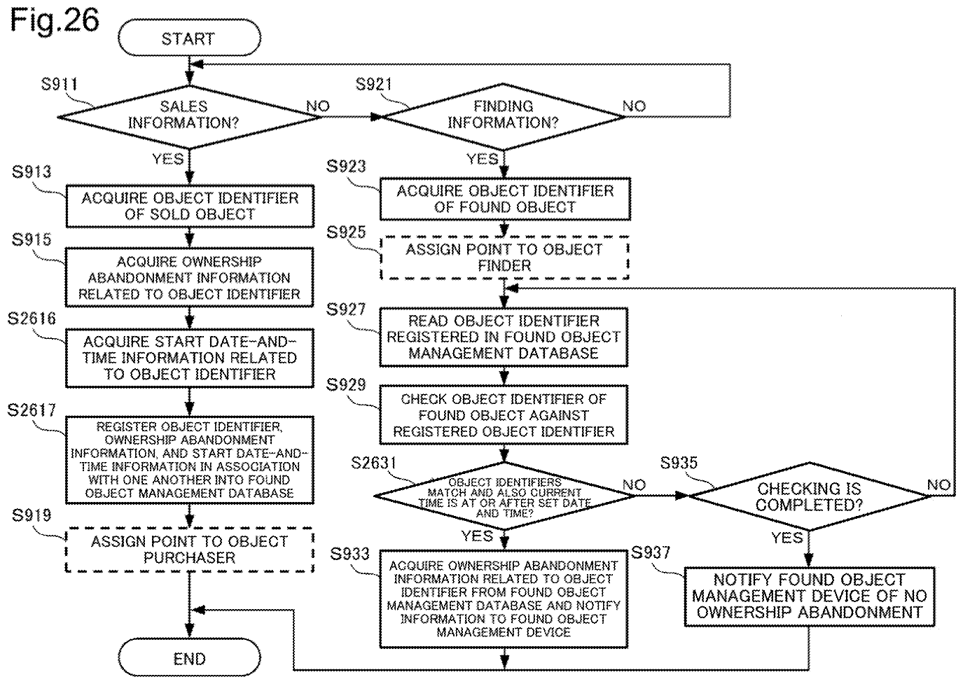

FIG. 26 is a flowchart illustrating a processing procedure in the found object management server 2320 as the information processing device according to the present example embodiment. In FIG. 26, a step similar to that in FIG. 9 is given the same step number, and redundant description is omitted.

When accessed from the sale management device 2310, the found object management server 2320 acquires, from the sale management device 2310, start date-and-time information related to the object identifier in a case of ownership abandonment, in Step S2616. Then, in Step S2617, the found object management server 2320 registers the object identifier of the sold object, the ownership abandonment information, and the start date-and-time information in association with one another into the found object management database 2321.

On the other hand, when accessed from the found object management device 230, the found object management server 2320 proceeds to Step S933 when the object identifier received from the found object management device 230 matches the object identifier registered in the found object management database 2321 and also the inquiry is made at or after the start date and time of ownership abandonment, in Step S2631.

According to the present example embodiment, in addition to the effects of the aforementioned example embodiments, a purchaser can set an abandonment date and time of ownership to a found object, and therefore management of a found object by flexible ownership control can be performed rather than by the alternative of whether to abandon ownership or not.

### Fifth Example Embodiment

Next, a found object management system according to a fifth example embodiment of the present disclosure will be described. Compared with the aforementioned second example embodiment to fourth example embodiment, the found object management system according to the present example embodiment differs in that a found object management device can confirm ownership of a found object at any date and time at any place by a smartphone as a mobile terminal instead of a terminal at a found object office. The remaining configuration and operation are similar to those of the second example embodiment to the fourth example embodiment, and therefore the same configurations and operations are respectively given the same reference signs, and detailed description thereof is omitted.

### Found Object Management System

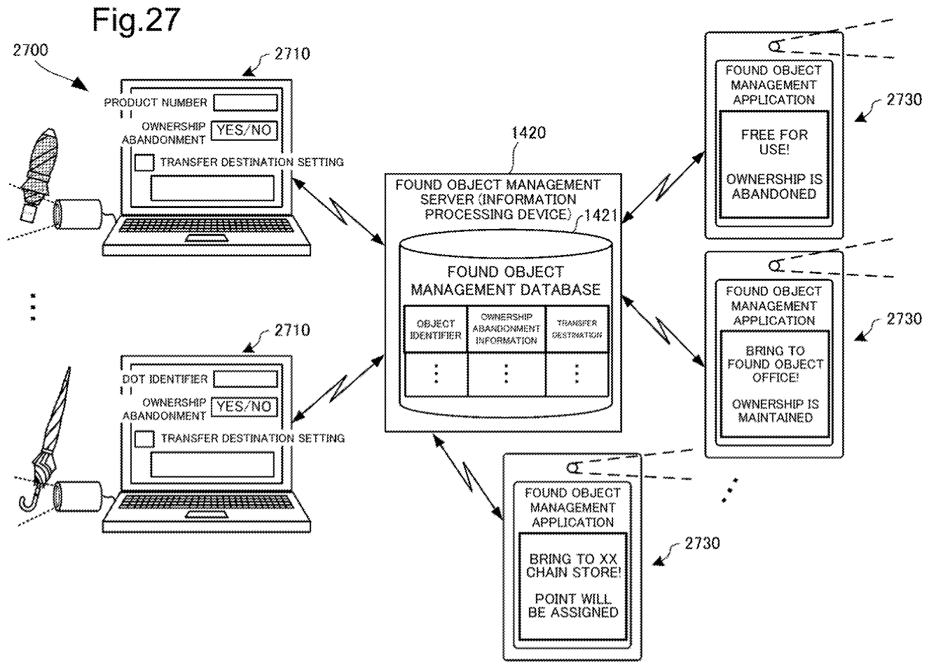

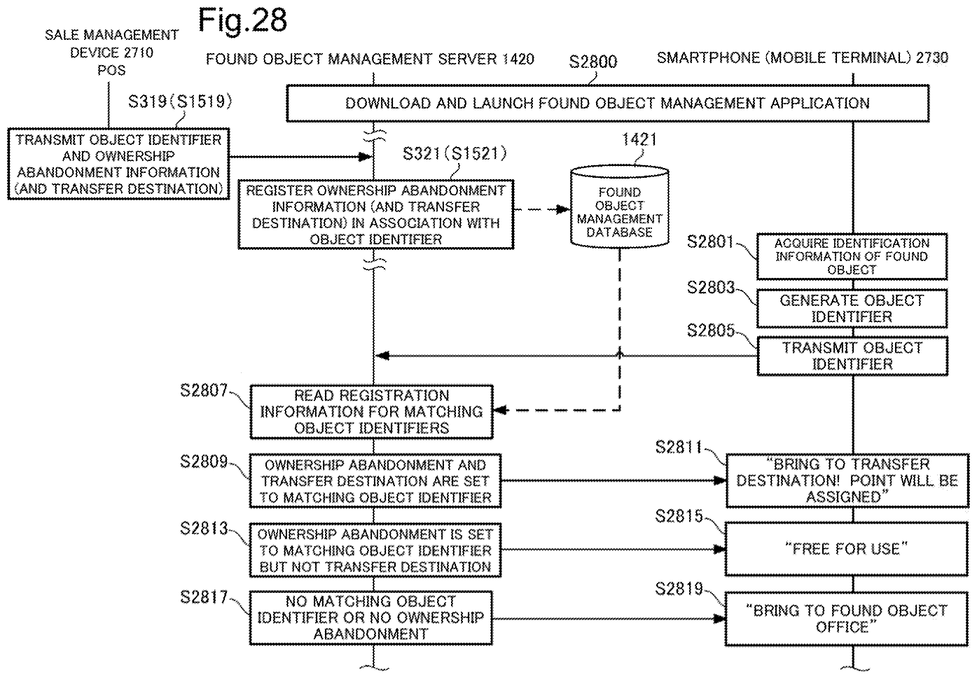

A configuration and an operation of a found object management system 2700 according to the present example embodiment will be described with reference to FIG. 27 and FIG. 28.

### Outline

FIG. 27 is a diagram illustrating an outline of the found object management system 2700 according to the present example embodiment. A component similar to that in FIG. 14 is given the same reference number, and redundant description is omitted.

A sale management device 2710 in the found object management system 2700 registers ownership abandonment information indicating whether to abandon ownership when a sold object is lost and then found, and also a transfer destination in a case of setting a transfer destination of the sold object when ownership is abandoned, in association with an object identifier of the sold object, into a found object management database 1421 in a found object management server 1420.

On the other hand, a smartphone 2730 as a found object management device in the found object management system 2700 acquires identification information from a found object, generates an object identifier from the identification information, and transmits the object identifier to the found object management server 1420. When an object identifier matching an object identifier of a found object exists in the found object management database 1421, the found object management server 1420 determines abandonment of ownership from ownership abandonment information associated with the object identifier. Then, when ownership is abandoned and a transfer destination of the found object associated with the object identifier exists, the found object management server 1420 instructs transfer to the transfer destination.

For example, examples such as an instruction “FREE FOR USE! OWNERSHIP IS ABANDONED.” in a case of ownership being abandoned but a transfer destination not being specified, an instruction “BRING TO FOUND OBJECT OFFICE! OWNERSHIP IS MAINTAINED.” in a case of ownership not being abandoned, and an instruction “BRING TO XX CHAIN STORE! POINT WILL BE ASSIGNED.” in a case of ownership being abandoned and a transfer destination being specified are illustrated on smartphones 2730 in FIG. 27.

### Operational Sequence

FIG. 28 is a sequence diagram illustrating an operation procedure of the found object management system 2700 according to the present example embodiment. In FIG. 28, an operation up to registration into the found object management database 1421 is common with FIG. 3A, FIG. 3B, FIG. 15, or the like, and therefore is omitted. Further, in FIG. 28, a step similar to that in FIG. 3A, FIG. 3B, FIG. 15, or the like is given the same step number, and redundant description is omitted.

In Step S2800, the smartphone 2730 downloads a found object management application from the found object management server 1420 and launches the application. The found object management application may be previously launched and be operating in the background, or may be launched at each inquiry about a found object.

In Step S2801, the smartphone 2730 acquires identification information of a found object with, for example, a built-in camera. In Step S2803, the smartphone 2730 generates an object identifier of the found object from the acquired identification information. Then, in Step S2805, the smartphone 2730 transmits the generated object identifier to the found object management server 1420.

In Step S2807, the found object management server 1420 reads registration information related to matching object identifiers, that is, ownership abandonment information, transfer destination information, and the like from the found object management database 1421. Then, in relation to FIG. 27, when determining that ownership abandonment information and transfer destination information that are related to the matching object identifiers are registered, the found object management server 1420 notifies the smartphone 2730 of a message notifying the above situation, in Step S2809. Specifically, in Step S2811, the smartphone 2730 displays “BRING TO TRANSFER DESTINATION! POINT WILL BE ASSIGNED.” When determining that ownership abandonment information related to the matching object identifiers exists but transfer destination information is not registered, the found object management server 1420 notifies the smartphone 2730 of a message notifying the above situation, in Step S2813. Specifically, in Step S2815, the smartphone 2730 displays “FREE FOR USE!” When determining that matching object identifiers do not exist or ownership abandonment information related to the matching object identifiers does not exist, the found object management server 1420 notifies the smartphone 2730 of a message notifying no abandonment of ownership, in Step S2817. Specifically, in Step S2819, the smartphone 2730 displays “BRING TO FOUND OBJECT OFFICE!”

### Functional Configuration of Smartphone

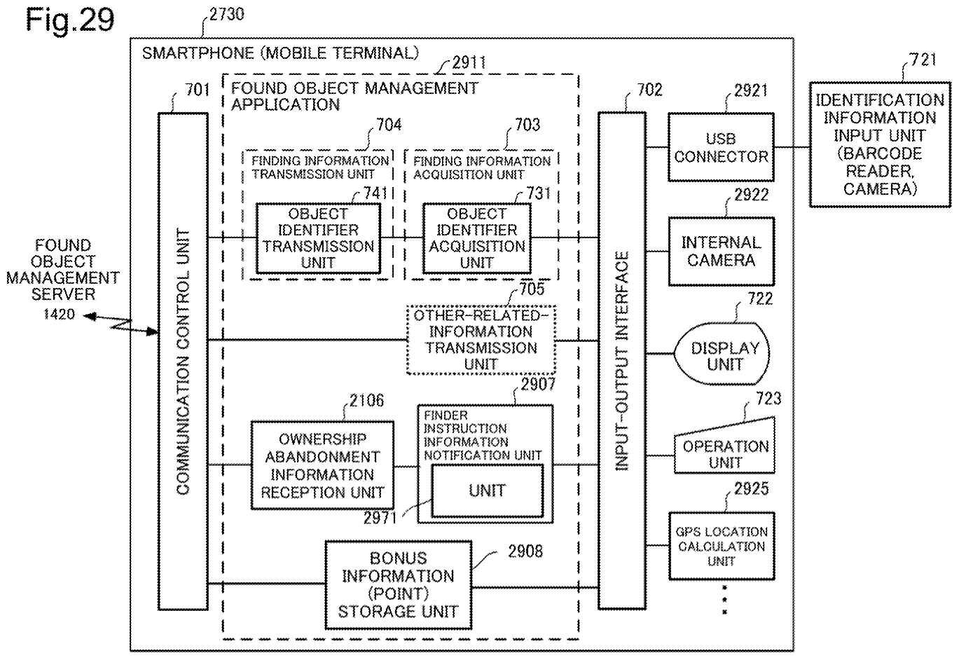

FIG. 29 is a block diagram illustrating a functional configuration of the smartphone 2730 as the found object management device according to the present example embodiment. In FIG. 29, a function configuration unit similar to that in FIG. 7 or FIG. 21 is given the same reference number, and redundant description is omitted.

The smartphone 2730 as the found object management device includes a communication control unit 701, an input-output interface 702, a finding information acquisition unit 703, a finding information transmission unit 704, an optional other-related-information transmission unit 705, an ownership abandonment information reception unit 2106, a finder instruction information notification unit 2907, and a bonus information (point) storage unit 2908. For example, the input-output interface 702 is connected to a USB connector 2921, an internal camera 2922, a display unit 722, an operation unit 723, and a GPS location calculation unit 2925. The USB connector 2921 may be connected to an identification information input unit 721 to which information being a source of an object identifier is input.

The finder instruction information notification unit 2907 includes an instruction message storage unit 2971 and based on reception of ownership abandonment information and/or transfer destination information related to an object identifier of a found object from the found object management server 1420, notifies display of a related finder instruction message and the like. The bonus information (point) storage unit 2908 acquires and stores bonus information such as an ownership abandonment setting at purchase of a sold object and an inquiry about a found object.

In the smartphone 2730, the finding information acquisition unit 703, the finding information transmission unit 704, the optional other-related-information transmission unit 705, the ownership abandonment information reception unit 2106, the finder instruction information notification unit 2907, and the bonus information (point) storage unit 2908 may be included in a found object management application 2911.

### Hardware Configuration of Smartphone

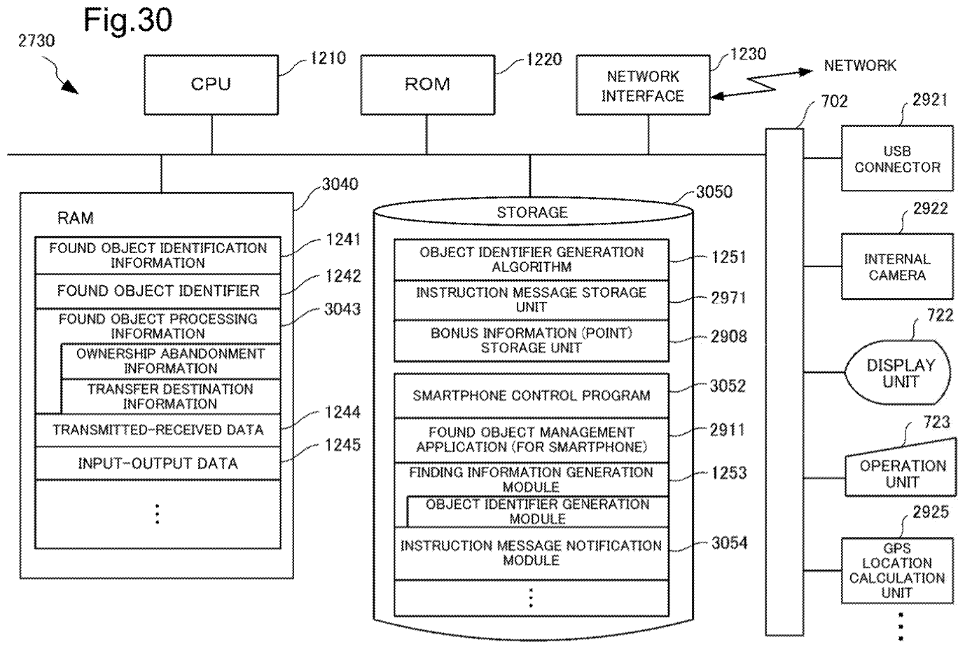

FIG. 30 is a block diagram illustrating a hardware configuration of the smartphone 2730 as the found object management device according to the present example embodiment. In FIG. 30, a component similar to that in FIG. 12 or FIG. 29 is given the same reference number, and redundant description is omitted.

A RAM 3040 stores found object processing information 3043 including ownership abandonment information and transfer destination information. A storage 3050 stores an instruction message storage unit 2971 storing an instruction message to a finder and the bonus information (point) storage unit 2908. Further, the storage 3050 stores, as programs, a smartphone control program 3052, a found object management application (for a smartphone) 2911, and an instruction message notification module 3054 notifying an instruction message.

### Processing Procedure in Smartphone

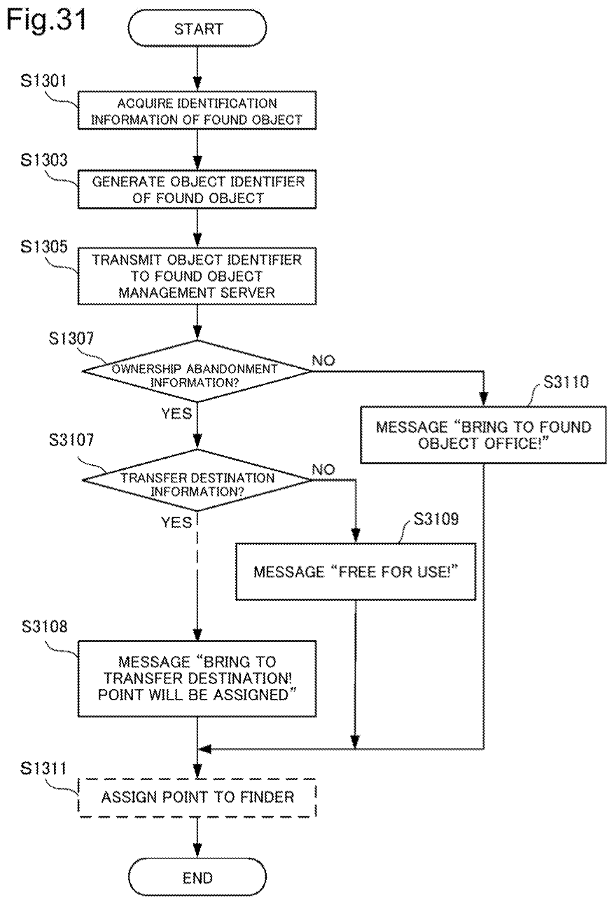

FIG. 31 is a flowchart illustrating a processing procedure in the smartphone 2730 as the found object management device according to the present example embodiment. In FIG. 31, a step similar to that in FIG. 13 is given the same step number, and redundant description is omitted.

When ownership is not abandoned, the smartphone 2730 outputs a message “BRING TO FOUND OBJECT OFFICE!” in Step S3110. In Step S3107, the smartphone 2730 determines existence or nonexistence of information about a transfer destination. When information about a transfer destination exists, the smartphone 2730 outputs a message “BRING TO TRANSFER DESTINATION! POINT WILL BE ASSIGNED.” in Step S3108. On the other hand, when information about a transfer destination does not exist, the smartphone 2730 outputs a message “FREE FOR USE!” in Step S3109.

According to the present example embodiment, in addition to the effects of the aforementioned example embodiments, ownership of a found object can be confirmed with a smartphone as a mobile terminal at any date and time at any place, and therefore a finder can dispose of a found object without bringing the object to a found object office, and time and expense for found object management can be further reduced.

### Other Example Embodiments

While the disclosure has been particularly shown and described with reference to exemplary embodiments thereof, the disclosure is not limited to these embodiments. It will be understood by those of ordinary skill in the art that various changes in form and details may be made therein without departing from the spirit and scope of the present disclosure as defined by the claims. Further, a system or a device in which different features included in the respective example embodiments are appropriately combined is also included in the scope of the present disclosure.

The present disclosure may be applied to a system configured with a plurality of pieces of equipment or may be applied to a single device. Furthermore, the present disclosure is also applicable when an information processing program providing the functions of the example embodiments is directly or remotely supplied to a system or a device. Accordingly, a program installed on a computer for providing the functions of the present disclosure with the computer, a medium storing the program, or a world wide web (WWW) server from which the program is downloaded are also included in the scope of the present disclosure. At least a non-transitory computer-readable medium storing a program causing a computer to execute the processing steps included in the aforementioned example embodiments is particularly included in the scope of the present disclosure.

### Other Expressions of Example Embodiments

The aforementioned example embodiments may also be described in part or in whole as the following Supplementary Notes but are not limited thereto.

### Supplementary Note 1

A found object management system including:

a sales information acquisition unit for, when an object is sold, acquiring a first object identifier for identifying the sold object and ownership abandonment information indicating that ownership of the sold object is abandoned when a purchaser loses the sold object;

a registration unit for registering the first object identifier and the ownership abandonment information in association with each other;

a finding information acquisition unit for acquiring a second object identifier for identifying a found object;

a checking unit for checking the second object identifier against the first object identifier; and

a notification unit for, when the second object identifier matches the first object identifier, notifying that ownership of the found object is abandoned.

### Supplementary Note 2

A found object management method including:

when an object is sold, acquiring a first object identifier for identifying the sold object and ownership abandonment information indicating that ownership of the sold object is abandoned when a purchaser loses the sold object;

registering the first object identifier and the ownership abandonment information in association with each other into a registration unit;

acquiring a second object identifier for identifying a found object;

checking the second object identifier against the first object identifier; and,

when the second object identifier matches the first object identifier, notifying that ownership of the found object is abandoned.

### Supplementary Note 3

A storage medium having a found object management program stored thereon, the found object management program causing a computer to execute:

sales information acquisition processing of, when an object is sold, acquiring a first object identifier for identifying the sold object and ownership abandonment information indicating that ownership of the sold object is abandoned when a purchaser loses the sold object;

registration processing of registering the first object identifier and the ownership abandonment information in association with each other;

finding information acquisition processing of acquiring a second object identifier for identifying a found object;

checking processing of checking the second object identifier against the first object identifier; and

notification processing of, when the second object identifier matches the first object identifier, notifying that ownership of the found object is abandoned.

### Supplementary Note 4

An information processing device including:

a registration unit for registering a first object identifier for identifying a sold object and ownership abandonment information indicating that ownership of the sold object is abandoned when a purchaser loses the sold object, in association with each other;

a finding information reception unit for receiving a second object identifier for identifying a found object;

a checking unit for checking the second object identifier against the first object identifier; and

a determination unit for, when the second object identifier matches the first object identifier, determining that ownership of the found object is abandoned.

### Supplementary Note 5

The information processing device according to Supplementary Note 4, wherein

the registration unit further registers, in association with the first object identifier, a transfer destination to which the found object is transferred when the ownership is abandoned, and

the information processing device further includes an instruction unit for instructing transfer of the found object the ownership of which is abandoned to the transfer destination.

### Supplementary Note 6

The information processing device according to Supplementary Note 5, wherein

the transfer destination includes a contribution recipient to which the found object is contributed, a public facility sharing the found object, a manufacturer manufacturing the found object or a seller selling the found object, a recycling agent recycling the found object, and a rental agent renting the found object.

### Supplementary Note 7

The information processing device according to any one of Supplementary Notes 4 to 6, further including:

a sales information reception unit for receiving the first object identifier and the ownership abandonment information from a sale management device for an object at purchase of the sold object by the purchaser; and

a bonus information transmission unit for transmitting bonus information to the purchaser when the ownership abandonment information is acquired.

### Supplementary Note 8

The information processing device according to any one of Supplementary Notes 4 to 7, wherein

each of the first object identifier and the second object identifier is a dot identifier extracted from a dot described on the object with a writing tool, a code identifier including a barcode attached to the object, or a feature point identifier extracted from a captured image of the object.

### Supplementary Note 9

The information processing device according to any one of Supplementary Notes 4 to 8, wherein

the registration unit further registers, in association with the first object identifier, a date and time at which abandonment of the ownership starts, and,

when the second object identifier matches the first object identifier and also a date and time at which the found object is found is at or after a date and time at which abandonment of the ownership starts, the determination unit determines that ownership of the found object is abandoned.

### Supplementary Note 10

A control method for an information processing device including:

registering a first object identifier for identifying a sold object and ownership abandonment information indicating that ownership of the sold object is abandoned when a purchaser loses the sold object, in association with each other, into a registration unit;

receiving a second object identifier for identifying a found object;

checking the second object identifier against the first object identifier; and,

when the second object identifier matches the first object identifier, determining that ownership of the found object is abandoned.

### Supplementary Note 11

The control method according to Supplementary Note 10, further including:

further registering, in association with the first object identifier, a transfer destination to which the found object is transferred when the ownership is abandoned; and

instructing transfer of the found object the ownership of which is abandoned to the transfer destination.

### Supplementary Note 12

The control method according to Supplementary Note 11, wherein

the transfer destination includes a contribution recipient to which the found object is contributed, a public facility sharing the found object, a manufacturer manufacturing the found object or a seller selling the found object, a recycling agent recycling the found object, and a rental agent renting the found object.

### Supplementary Note 13

The control method according to any one of Supplementary Notes 10 to 12, further including:

receiving the first object identifier and the ownership abandonment information from a sale management device for an object at purchase of the sold object by the purchaser; and

transmitting bonus information to the purchaser when the ownership abandonment information is acquired.

### Supplementary Note 14

The control method according to any one of Supplementary Notes 10 to 13, wherein

each of the first object identifier and the second object identifier is a dot identifier extracted from a dot described on the object with a writing tool, a code identifier including a barcode attached to the object, or a feature point identifier extracted from a captured image of the object.

### Supplementary Note 15

The control method according to any one of Supplementary Notes 10 to 14, further including:

further registering, in association with the first object identifier, a date and time at which abandonment of the ownership starts; and,

when the second object identifier matches the first object identifier and also a date and time at which the found object is found is at or after a date and time at which abandonment of the ownership starts, determining that ownership of the found object is abandoned.

### Supplementary Note 16

A storage medium having an information processing program stored thereon, the information processing program causing a computer to execute:

registration processing of registering a first object identifier for identifying a sold object and ownership abandonment information indicating that ownership of the sold object is abandoned when a purchaser loses the sold object, in association with each other, into a registration unit;

finding information reception processing of receiving a second object identifier for identifying a found object;

checking processing of checking the second object identifier against the first object identifier; and

determination processing of, when the second object identifier matches the first object identifier, determining that ownership of the found object is abandoned.

### Supplementary Note 17

The storage medium according to Supplementary Note 16, wherein

the registration processing further registers, in association with the first object identifier, a transfer destination to which the found object is transferred when the ownership is abandoned, and

the information processing program further causes the computer to execute instruction processing of instructing transfer of the found object the ownership of which is abandoned to the transfer destination.

### Supplementary Note 18

The storage medium according to Supplementary Note 17, wherein

the transfer destination includes a contribution recipient to which the found object is contributed, a public facility sharing the found object, a manufacturer manufacturing the found object or a seller selling the found object, a recycling agent recycling the found object, and a rental agent renting the found object.

### Supplementary Note 19

The storage medium according to any one of Supplementary Notes 16 to 18, wherein

the information processing program further causes the computer to execute:

sales information reception processing of receiving the first object identifier and the ownership abandonment information from a sale management device for an object at purchase of the sold object by the purchaser; and

bonus information transmission processing of transmitting bonus information to the purchaser when the ownership abandonment information is acquired.

### Supplementary Note 20

The storage medium according to any one of Supplementary Notes 16 to 19, wherein

each of the first object identifier and the second object identifier is a dot identifier extracted from a dot described on the object with a writing tool, a code identifier including a barcode attached to the object, or a feature point identifier extracted from a captured image of the object.

### Supplementary Note 21

The storage medium according to any one of Supplementary Notes 16 to 20, wherein

the registration processing further registers, in association with the first object identifier, a date and time at which abandonment of the ownership starts, and,

when the second object identifier matches the first object identifier and also a date and time at which the found object is found is at or after a date and time at which abandonment of the ownership starts, the determination processing determines that ownership of the found object is abandoned.

### Supplementary Note 22

A sale management device including:

a sales information acquisition unit for, when an object is sold, acquiring a first object identifier for identifying the sold object and ownership abandonment information indicating that ownership of the sold object is abandoned when a purchaser loses the sold object; and

a sales information transmission unit for transmitting, to an information processing device, the first object identifier and the ownership abandonment information to be registered in association with each other into a registration unit in the information processing device.

### Supplementary Note 23

The sale management device according to Supplementary Note 22, further including

an assignment unit for assigning bonus information to a purchaser of the sold object when the ownership abandonment information is set.

### Supplementary Note 24

The sale management device according to Supplementary Note 22 or 23, wherein

the sales information acquisition unit further acquires a transfer destination to which the sold object is transferred when the ownership is abandoned, and

the sales information transmission unit further transmits the transfer destination to the information processing device in association with the first object identifier.

### Supplementary Note 25

The sale management device according to Supplementary Note 24, wherein

the transfer destination includes a contribution recipient to which a found object is contributed, a public facility sharing the found object, a manufacturer manufacturing the found object or a seller selling the found object, a recycling agent recycling the found object, and a rental agent renting the found object.

### Supplementary Note 26

The sale management device according to any one of Supplementary Notes 22 to 25, wherein

the first object identifier is a dot identifier extracted from a dot described on the sold object with a writing tool, a code identifier including a barcode attached to the sold object, or a feature point identifier extracted from a captured image of the sold object.

### Supplementary Note 27

The sale management device according to any one of Supplementary Notes 22 to 26, wherein

the sales information acquisition unit includes:

an image capture unit for capturing an image of a dot described on the sold object with a writing tool;

an extraction unit for extracting a dot identifier from the captured dot image; and

an input unit for receiving input of the ownership abandonment information in association with the extracted dot identifier.

### Supplementary Note 28

The sale management device according to any one of Supplementary Notes 22 to 27, wherein

the sales information acquisition unit further acquires a date and time at which abandonment of the ownership starts, and

the sales information transmission unit further transmits the date and time to the information processing device in association with the first object identifier.

### Supplementary Note 29

The sale management device according to any one of Supplementary Notes 22 to 28, wherein

the sale management device includes a point of sale system (POS) terminal.

### Supplementary Note 30

A control method for a sale management device including:

when an object is sold, acquiring a first object identifier for identifying the sold object and ownership abandonment information indicating that ownership of the sold object is abandoned when a purchaser loses the sold object; and

transmitting, to an information processing device, the first object identifier and the ownership abandonment information to be registered in association with each other into a registration unit in the information processing device.

### Supplementary Note 31

The control method according to Supplementary Note 30, further including

assigning bonus information to a purchaser of the sold object when the ownership abandonment information is set.

### Supplementary Note 32

The control method according to Supplementary Note 30 or 31, further including:

further acquiring a transfer destination to which the sold object is transferred when the ownership is abandoned; and

further transmitting the transfer destination to the information processing device in association with the first object identifier.

### Supplementary Note 33

The control method according to Supplementary Note 32, wherein

the transfer destination includes a contribution recipient to which a found object is contributed, a public facility sharing the found object, a manufacturer manufacturing the found object or a seller selling the found object, a recycling agent recycling the found object, and a rental agent renting the found object.

### Supplementary Note 34

The control method according to any one of Supplementary Notes 30 to 33, wherein

the first object identifier is a dot identifier extracted from a dot described on the sold object with a writing tool, a code identifier including a barcode attached to the sold object, or a feature point identifier extracted from a captured image of the sold object.

### Supplementary Note 35

The control method according to any one of Supplementary Notes 30 to 34, further including:

capturing an image of a dot described on the sold object with a writing tool;

extracting a dot identifier from the captured dot image; and

receiving input of the ownership abandonment information in association with the extracted dot identifier.

### Supplementary Note 36

The control method according to any one of Supplementary Notes 30 to 35, further including:

further acquiring a date and time at which abandonment of the ownership starts; and

further transmitting the date and time to the information processing device in association with the first object identifier.

### Supplementary Note 37

The control method according to any one of Supplementary Notes 30 to 36, wherein

the sale management device includes a point of sale system (POS) terminal.

### Supplementary Note 38

A storage medium having a control program for a sale management device stored thereon, the control program causing a computer to execute:

sales information acquisition processing of, when an object is sold, acquiring a first object identifier for identifying the sold object and ownership abandonment information indicating that ownership of the sold object is abandoned when a purchaser loses the sold object; and

sales information transmission processing of transmitting, to an information processing device, the first object identifier and the ownership abandonment information to be registered in association with each other into a registration unit in the information processing device.

### Supplementary Note 39

The storage medium according to Supplementary Note 38, wherein

the control program further causes the computer to execute assignment processing of assigning bonus information to a purchaser of the sold object when the ownership abandonment information is set.

### Supplementary Note 40

The storage medium according to Supplementary Note 38 or 39, wherein

the sales information acquisition processing further acquires a transfer destination to which the sold object is transferred when the ownership is abandoned, and

the sales information transmission processing further transmits the transfer destination to the information processing device in association with the first object identifier.

### Supplementary Note 41

The storage medium according to Supplementary Note 40, wherein

the transfer destination includes a contribution recipient to which a found object is contributed, a public facility sharing the found object, a manufacturer manufacturing the found object or a seller selling the found object, a recycling agent recycling the found object, and a rental agent renting the found object.

### Supplementary Note 42

The storage medium according to any one of Supplementary Notes 38 to 41, wherein

the first object identifier is a dot identifier extracted from a dot described on the sold object with a writing tool, a code identifier including a barcode attached to the sold object, or a feature point identifier extracted from a captured image of the sold object.

### Supplementary Note 43

The storage medium according to any one of Supplementary Notes 38 to 42, wherein

the sales information acquisition processing includes:

image capture processing of capturing an image of a dot described on the sold object with a writing tool;

extraction processing of extracting a dot identifier from the captured dot image; and

input processing of receiving input of the ownership abandonment information in association with the extracted dot identifier.

### Supplementary Note 44

The storage medium according to any one of Supplementary Notes 38 to 43, wherein

the sales information acquisition processing further acquires a date and time at which abandonment of the ownership starts; and

the sales information transmission processing further transmits the date and time to the information processing device in association with the first object identifier.

### Supplementary Note 45

The storage medium according to any one of Supplementary Notes 38 to 44, wherein

the sale management device includes a point of sale system (POS) terminal.

### Supplementary Note 46

A communications terminal including:

a finding information acquisition unit for acquiring a second object identifier for identifying a found object;

a finding information transmission unit for transmitting the second object identifier to an information processing device;

an abandonment information reception unit for receiving ownership abandonment information indicating that ownership of the found object is abandoned, the abandonment information being notified from the information processing device when a first object identifier for identifying a sold object matching the second object identifier is registered in a registration unit in the information processing device; and

an abandonment information notification unit for notifying that ownership of the found object is abandoned, based on the received ownership abandonment information.

### Supplementary Note 47

The communications terminal according to Supplementary Note 46, wherein

the abandonment information reception unit receives transfer destination information indicating a transfer destination of the object along with the ownership abandonment information, and

the abandonment information notification unit further notifies a transfer destination of the object.

### Supplementary Note 48

The communications terminal according to Supplementary Note 46 or 47, wherein

each of the first object identifier and the second object identifier is a dot identifier extracted from a dot described on the object with a writing tool, a code identifier including a barcode attached to the object, or a feature point identifier extracted from a captured image of the object.

### Supplementary Note 49

The communications terminal according to any one of Supplementary Notes 46 to 48, wherein

the finding information acquisition unit includes:

an image capture unit for capturing an image of a dot described on the found object with a writing tool; and

an extraction unit for extracting a dot identifier from the captured dot image.

### Supplementary Note 50

The communications terminal according to any one of Supplementary Notes 46 to 49, wherein

the communications terminal is a communications terminal in a found object office handling the found object or a communications terminal including a smartphone.

### Supplementary Note 51

The communications terminal according to Supplementary Note 47, wherein

the communications terminal is a communications terminal including a smartphone and

further includes a bonus information acquisition unit for acquiring bonus information for transmission of the second object identifier or transfer of the found object to a transfer destination.

### Supplementary Note 52

A control method for a communications terminal including:

acquiring a second object identifier for identifying a found object;

transmitting the second object identifier to an information processing device;

receiving ownership abandonment information indicating that ownership of the found object is abandoned, the abandonment information being notified from the information processing device when a first object identifier for identifying a sold object matching the second object identifier is registered in a registration unit in the information processing device; and

notifying that ownership of the found object is abandoned, based on the received ownership abandonment information.

### Supplementary Note 53

The control method according to Supplementary Note 52, further including:

receiving transfer destination information indicating a transfer destination of the object along with the ownership abandonment information; and

further notifying a transfer destination of the object.

### Supplementary Note 54

The control method according to Supplementary Note 52 or 53, wherein

each of the first object identifier and the second object identifier is a dot identifier extracted from a dot described on the object with a writing tool, a code identifier including a barcode attached to the object, or a feature point identifier extracted from a captured image of the object.

### Supplementary Note 55

The control method according to any one of Supplementary Notes 52 to 54, further including:

capturing an image of a dot described on the found object with a writing tool; and

extracting a dot identifier from the captured dot image.

### Supplementary Note 56

The control method according to any one of Supplementary Notes 52 to 55, wherein

the communications terminal is a communications terminal in a found object office handling the found object or a communications terminal including a smartphone.

### Supplementary Note 57

The control method according to Supplementary Note 53, wherein

the communications terminal is a communications terminal including a smartphone, and

acquires bonus information for transmission of the second object identifier or transfer of the found object to a transfer destination.

### Supplementary Note 58

A storage medium having an application program for a communications terminal stored thereon, the application program causing a computer to execute:

finding information acquisition processing of acquiring a second object identifier for identifying a found object;

finding information transmission processing of transmitting the second object identifier to an information processing device;

abandonment information reception processing of receiving ownership abandonment information indicating that ownership of the found object is abandoned, the abandonment information being notified from the information processing device when a first object identifier for identifying a sold object matching the second object identifier is registered in a registration unit in the information processing device; and

abandonment information notification processing of notifying that ownership of the found object is abandoned, based on the received ownership abandonment information.

### Supplementary Note 59

The storage medium according to Supplementary Note 58, wherein

transfer destination information indicating a transfer destination of the object is received along with the ownership abandonment information in the abandonment information reception processing, and

a transfer destination of the object is further notified in the abandonment information notification processing.

### Supplementary Note 60

The storage medium according to Supplementary Note 58 or 59, wherein

each of the first object identifier and the second object identifier is a dot identifier extracted from a dot described on the object with a writing tool, a code identifier including a barcode attached to the object, or a feature point identifier extracted from a captured image of the object.

### Supplementary Note 61

The storage medium according to any one of Supplementary Notes 58 to 60, wherein

the finding information acquisition processing includes:

image capture processing of capturing, by an image capture unit, an image of a dot described on the found object with a writing tool; and

extraction processing of extracting a dot identifier from the captured dot image.

### Supplementary Note 62

The storage medium according to any one of Supplementary Notes 58 to 61, wherein

the communications terminal is a communications terminal in a found object office handling the found object or a communications terminal including a smartphone.

### Supplementary Note 63

The storage medium according to Supplementary Note 59, wherein

the communications terminal is a communications terminal including a smartphone, and

the application program further causes the computer to execute

bonus information acquisition processing of acquiring bonus information related to transmission of the second object identifier or transfer of the found object to a transfer destination.

While the disclosure has been particularly shown and described with reference to exemplary embodiments thereof, the disclosure is not limited to these embodiments. It will be understood by those of ordinary skill in the art that various changes in form and details may be made therein without departing from the spirit and scope of the present disclosure as defined by the claims.

This application is based upon and claims the benefit of priority from Japanese patent application No. 2017-232792, filed on Dec. 4, 2017, the disclosure of which is incorporated herein in its entirety by reference.

### REFERENCE SIGNS LIST

100 Found object management system
101 Sales information acquisition unit
102 Ownership abandonment information registration unit
103 Finding information acquisition unit
104 Checking unit
105 Ownership abandonment notification unit
121 First object identifier
122 Ownership abandonment information
200 Found object management system
201 Found object management system
202 Found object management system
203 Found object management system
210 Sale management device
211 Sale management device
212 Sale management device
213 Sale management device
214 Sale management device
215 Sale management device
216 Sale management device
217 Sale management device
218 Sale management device
219 Sale management device
220 Found object management server
221 Found object management database
230 Found object office, Found object management device
231 Found object management device
232 Found object management device
233 Found object management device
234 Found object management device
235 Found object management device
236 Found object management device
240 Found object depository
250 Transfer destination
251 Finder
252 Contribution recipient
254 Seller
255 Rental agent
256 Disposal
260 Object identifier table
261 Object (product)
262 Object identifier identification information
263 Object identifier
264 Generation method
266 Dot identifier table
271 Dot describing material
272 Dot description medium
273 Dot image capture method
274 Extraction method of a dot image feature value
401 Communication control unit
402 Sales information reception unit
403 Sales information registration unit
404 Finding information reception unit
405 Object identifier checking unit
406 Ownership abandonment determination unit
407 Ownership abandonment information notification unit
421 Object identifier acquisition unit
422 Ownership abandonment information acquisition unit
441 Object identifier acquisition unit
510 Configuration
511 Object identifier
512 Ownership abandonment information
513 Other-object-related information
520 Configuration
521 Ownership abandonment information
522 Object identifier
523 Other-object-related information
601 Communication control unit
602 Input-output interface
603 Sales information acquisition unit
604 Sales information transmission unit
605 Other-related-information transmission unit
606 Ownership abandonment information registration completion reception unit
607 Ownership abandonment information registration completion processing unit
610 POS terminal
611 Found object management application
621 Identification information input unit
622 Display unit
623 Operation unit
631 Object identifier acquisition unit
632 Ownership abandonment information acquisition unit
641 Object identifier transmission unit
642 Ownership abandonment information transmission unit
701 Communication control unit
702 Input-output interface
703 Finding information acquisition unit
704 Finding information transmission unit
705 Other-related-information transmission unit
706 Ownership abandonment information reception unit
707 Ownership abandonment information notification unit
710 Found object management terminal
711 Found object management application
721 Identification information input unit
722 Display unit
723 Operation unit
731 Object identifier acquisition unit
741 Object identifier transmission unit
810 CPU
820 ROM
830 Network interface
840 RAM
841 Object identifier
842 Ownership abandonment information
843 Object identifier
844 Object identifier
845 Check result
846 Ownership abandonment information
847 Transmitted-received data
850 Storage
851 Found object management server control program
852 Sales information acquisition module
853 Finding information acquisition module
854 Object identifier checking module
855 Ownership abandonment determination module
856 Ownership abandonment notification module
1010 CPU
1020 ROM
1030 Network interface
1040 RAM
1041 Checkout result
1042 Identification information
1043 Object identifier
1044 Ownership abandonment information
1045 Ownership abandonment information setting completion information
1046 Transmitted-received data
1047 Input-output data
1050 Storage
1051 Object identifier extraction algorithm
1052 Sale management device control program
1053 Sales information generation module
1054 Object-related information acquisition module
1210 CPU
1220 ROM
1230 Network interface
1240 RAM
1241 Identification information
1242 Object identifier
1243 Ownership abandonment information
1244 Transmitted-received data
1245 Input-output data
1250 Storage
1251 Object identifier extraction algorithm
1252 Found object management device control program
1253 Finding information generation module
1254 Ownership abandonment information notification module
1400 Found object management system
1410 Sale management device
1420 Found object management server
1421 Found object management database
1430 Found object management device
1602 Sales information reception unit
1606 Ownership abandonment determination unit
1607 Destination storage notification unit
1623 Transfer destination acquisition unit
1714 Transfer destination information
1903 Sales information acquisition unit
1904 Sales information transmission unit
1910 POS terminal
1911 Found object management application
1933 Transfer destination information acquisition unit
1943 Transfer destination information transmission unit
2106 Ownership abandonment information reception unit
2107 Ownership abandonment information notification unit
2110 Found object management terminal
2111 Found object management application
2310 Sale management device
2314 Date and time information
2320 Found object management server
2321 Found object management database
2402 Sales information reception unit
2406 Ownership abandonment determination unit
2423 Start date-and-time acquisition unit
2700 Found object management system
2710 Sale management device
2730 Smartphone
2907 Finder instruction information notification unit
2908 Bonus information (point) storage unit
2911 Found object management application
2921 Connector
2922 Internal camera
2925 Location calculation unit
2971 Instruction message storage unit
3040 RAM
3043 Processing information
3050 Storage
3052 Smartphone control program
3054 Instruction message notification module

1. A found object management system comprising:
at least one memory configured to store instructions; and
at least one processor configured to execute the instructions to:
acquire, when an object is sold, a first object identifier for identifying the sold object and ownership abandonment information indicating that ownership of the sold object is abandoned when a purchaser loses the sold object;
register the first object identifier and the ownership abandonment information in association with each other;
acquire a second object identifier for identifying a found object;
check the second object identifier against the first object identifier; and
notify, when the second object identifier matches the first object identifier, that ownership of the found object is abandoned.

2.-9. (canceled)

10. A control method for an information processing device comprising:
registering a first object identifier for identifying a sold object and ownership abandonment information indicating that ownership of the sold object is abandoned when a purchaser loses the sold object, in association with each other;
receiving a second object identifier for identifying a found object;
checking the second object identifier against the first object identifier; and,
when the second object identifier matches the first object identifier, determining that ownership of the found object is abandoned.

11. The control method according to claim 10, further comprising:
further registering, in association with the first object identifier, a transfer destination to which the found object is transferred when the ownership is abandoned; and
instructing transfer of the found object the ownership of which is abandoned to the transfer destination.

12. The control method according to claim 11, wherein
the transfer destination includes a contribution recipient to which the found object is contributed, a public facility sharing the found object, a manufacturer manufacturing the found object or a seller selling the found object, a recycling agent recycling the found object, and a rental agent renting the found object.

13. The control method according to claim 10, further comprising:
receiving the first object identifier and the ownership abandonment information from a sale management device for an object at purchase of the sold object by the purchaser; and
transmitting bonus information to the purchaser when the ownership abandonment information is acquired.

14. The control method according to claim 10, wherein
each of the first object identifier and the second object identifier is a dot identifier extracted from a dot described on the object with a writing tool, a code identifier including a barcode attached to the object, or a feature point identifier extracted from a captured image of the object.

15. The control method according to claim 10, further comprising:
further registering, in association with the first object identifier, a date and time at which abandonment of the ownership starts; and,
when the second object identifier matches the first object identifier and also a date and time at which the found object is found is at or after a date and time at which abandonment of the ownership starts, determining that ownership of the found object is abandoned.

16.-51. (canceled)

52. A control method for a communications terminal comprising:
acquiring a second object identifier for identifying a found object;
transmitting the second object identifier to an information processing device;
receiving ownership abandonment information indicating that ownership of the found object is abandoned, the abandonment information being notified from the information processing device when a first object identifier for identifying a sold object matching the second object identifier is registered in the information processing device; and
notifying that ownership of the found object is abandoned, based on the received ownership abandonment information.

53. The control method according to claim 52, further comprising:
receiving transfer destination information indicating a transfer destination of the object along with the ownership abandonment information; and
further notifying a transfer destination of the object.

54. The control method according to claim 52, wherein
each of the first object identifier and the second object identifier is a dot identifier extracted from a dot described on the object with a writing tool, a code identifier including a barcode attached to the object, or a feature point identifier extracted from a captured image of the object.

55. The control method according to claim 52, further comprising:
capturing an image of a dot described on the found object with a writing tool; and
extracting a dot identifier from the captured dot image.

56. The control method according to claim 52, wherein
the communications terminal is a communications terminal in a found object office handling the found object or a communications terminal including a smartphone.

57. The control method according to claim 54, wherein
the communications terminal is a communications terminal including a smartphone and acquires bonus information for transmission of the second object identifier or transfer of the found object to a transfer destination.

58.-63. (canceled)
